(19) United States
(12) Patent Application Publication
(10) Pub. No.: US 2025/0363163 A1
(43) Pub. Date: Nov. 27, 2025

(54) ARTIFICIAL INTELLIGENCE SYSTEM FOR UTILIZING MACHINE LEARNING MODELS TO PROCESS, ORGANIZE AND MANAGE TANGIBLE OBJECTS AND ASSOCIATED METADATA

(71) Applicant: AR-Worx, LLC, West Palm Beach, FL (US)

(72) Inventors: Johannes Csonka, Lake Worth, FL (US); Kyle Bush, Palm Beach Gardens, FL (US)

(73) Assignee: AR-Worx, LLC, West Palm Beach, FL (US)

(21) Appl. No.: 19/215,090

(22) Filed: May 21, 2025

Related U.S. Application Data
(60) Provisional application No. 63/650,243, filed on May 21, 2024.

(51) Int. Cl. G06F 16/45; G06F 16/435

(52) U.S. Cl. CPC G06F 16/45; G06F 16/435

(57) ABSTRACT

A system for utilizing machine learning models and other technologies to process, organize, and manage tangible object and associated metadata is provided. The system captures media content of an object in an environment and analyzes the media content to identify the object. The system determines whether the object matches an object in a profile of a user. If the object matches the object in the profile, the system retrieves metadata associated with the object from the profile to provide further context for the object. The system updates the metadata for the object and stores the updated metadata in the profile. If the system determines that the object does not match an object in the profile, the system determines that the object is a new object and adds the object to the profile. The system generates and stores metadata associated with the new object in the profile to track the object.

### CROSS REFERENCE TO RELATED APPLICATIONS

The present application claims priority to and the benefit of U.S. Provisional Patent Application No. 63/650,243, filed on May 21, 2024, the entirety of which is hereby incorporated by reference.

### FIELD OF THE INVENTION

The present application relates to artificial intelligence technologies, machine learning technologies, object detection technologies, object management technologies, metadata generation technologies, marking technologies, and, more particularly, to a system for utilizing machine learning models and other technologies to process, organize, and manage tangible objects and associated metadata.

### BACKGROUND

In today's society, it has become increasingly important for a user, system, or a business to be able to effectively track and monitor objects, assets, and possessions. Notably, users often resort to using tedious, time-consuming, or ineffective methods to track and monitor such objects, assets, and possessions. For example, some users resort to personally keeping track of various objects by meticulously cataloguing the objects in notebooks or other tedious ways of tracking objects. Such tedious ways of tracking objects are not only time consuming, but are also often prone to errors and are difficult to maintain on a regular basis. Some users even try to keep track of objects and assets using their own memory, which results in even more errors and becomes increasingly difficult as the number of objects that need to be tracked increases. To assist in tracking objects and assets, some users utilize various forms of technology to assist them in tracking objects and assets. For example, in addition to or instead of using paper notebooks, some users utilize word processing software to input data associated with the objects in an easily readable, savable, and transferrable form. While word processing software and related software technologies have advantages over traditional notebook cataloguing, utilizing such software to track objects and assets is still cumbersome and time consuming. Additionally, tracking objects through such software is still error prone and inconvenient.

Based on at least the foregoing, there remains room for substantial enhancements to existing technologies and processes and for the development of new technologies and processes to facilitate tracking, monitoring, and management of objects. For example, current technologies may be improved and enhanced so as to provide for more effective analyzing of objects, identification of objects, tracking the condition of objects, performing actions with respect to objects, classifying objects, and providing various other improvements and enhancements. Such improvements and enhancements to methodologies and technologies may provide for reduced errors associated with tracking objects, increase efficiency, more robust object detection capabilities, optimized tracking capabilities, more robust management capabilities, and a variety of other benefits.

### SUMMARY

A system and accompanying methods for utilizing models and other technologies to process, organize, and manage tangible objects and associated metadata are disclosed. In particular, the system and methods can utilize computer vision techniques, machine learning models, or a combination thereof, to identify, track, manage, and keep inventory of objects and/or assets in an electronic format that is convenient, reliable, and efficient. In certain embodiments, the system and methods include capturing media content of an object of interest in a particular location, such as an environment. The system and methods can analyze the media content taken of the object and can utilize computer vision techniques and/or machine learning models to identify the object. Once the object is identified, the system and methods can determine whether the identified object matches an object corresponding to an asset of a profile of a user. If the identified object is determined to match the object corresponding to the asset of the profile of the user, the system and methods can determine that the identified object is the object corresponding to the object in the profile. Based on determining that the identified object matches the object corresponding to the asset, the system and methods can include retrieving or providing access to metadata associated with the object. The system and methods can also update the metadata based on the media content and/or inputs received by the system.

If the identified object does not match an object corresponding to an asset of the profile, the system and methods can classify the identified object as a new asset for inclusion as an asset of the profile of the user. The system and methods can generate metadata associated with the object, such as based on the media content and/or inputs, and can store the metadata in the profile as being associated with the new asset. Whether the object is an existing object corresponding to an asset or a new object that is a new asset, the system and methods can determine whether an action needs to be performed with respect to the object. If an action associated with the object needs to be performed, the system and methods can facilitate performance of the action associated with the object. The system and methods can then train the machine learning models based on the media content, the metadata, the analyses, the identifications, and/or other actions conducted by the system to further enhance the capabilities and performance of the machine learning models. If an action does not need to be performed with respect to the object, the system and methods can proceed to directly train the machine learning models without facilitating performance of an action with respect to the object.

In certain embodiments, a system for utilizing machine learning models and/or other technologies to process, organize, and manage tangible object and associated metadata is provided. The system may include a memory that stores instructions and a processor that executes the instructions to perform various operations of the system. In certain embodiments, the system can perform an operation that includes analyzing, by utilizing one or more machine learning models, media content associated with a first object. In certain embodiments, the system can perform an operation that includes identifying the first object based on analyzing the media content using the one or more machine learning models. In certain embodiments, the one or more machine learning models can utilize any number of computer vision techniques to perform the identification. In certain embodiments, the system can perform an operation that includes determining whether the at least one first object matches a second object corresponding to an asset of a plurality of assets associated with a profile, such as a profile of a user. In certain embodiments, the system can perform an operation that includes determining, based on the first object being determined to match the second object, that the first object is the second object. In certain embodiments, the system can perform an operation that includes retrieving, based on the first object matching the second object, metadata associated with the second object. In certain embodiments, the system can perform an operation that includes classifying, based on the first object being determined to not match the second object, the first object as a new asset for inclusion in the plurality of assets associated with the profile.

In certain embodiments, a method for utilizing machine learning models and/or other technologies to process, organize, and manage tangible object and associated metadata is disclosed. The method may include a memory that stores instructions and a processor that executes the instructions to perform the functionality of the method. In certain embodiments, the method can be performed by utilizing the system and/or other systems. In certain embodiments, the method can include analyzing, by utilizing one or more machine learning models, media content associated with a first object. In certain embodiments, the method can include identifying the first object based on analyzing the media content and by utilizing one or more computer vision techniques utilized by the one or more machine learning models. In certain embodiments, the method can include determining whether the first object matches a second object corresponding to an asset of a plurality of assets associated with a profile. In certain embodiments, the method can include determining, based on the first object matching the second object, that the first object is the second object. In certain embodiments, the method can include obtaining, based on the first object matching the second object, metadata associated with the second object. In certain embodiments, the method can include classifying, based on the first object being determined to not match the second object, the first object as a new asset for inclusion in the plurality of assets associated with the profile.

According to further embodiments, a computer-readable device comprising instructions, which, when loaded and executed by a processor cause the processor to be configured to: analyze, by utilizing at least one machine learning model media content associated with at least one first object; identify the at least one first object based on analyzing the media content and by utilizing at least one computer vision technique utilized by the at least one machine learning model; determine whether the at least one first object matches at least one second object corresponding to an asset of a plurality of assets associated with a profile; determine, based on the at least one first object being determined to match the at least one second object, that the at least one first object is the at least one second object; retrieve, based on the at least one first object matching the at least one second object, metadata associated with the at least one second object; and classify, based on the at least one first object being determined to not match the at least one second object, the at least one first object as a new asset for inclusion in the plurality of assets associated with the profile.

These and other features of the systems and methods for utilizing machine learning models and/or other technologies to process, organize, and manage tangible objects and associated metadata are described in the following detailed description, drawings, and appended claims.

### BRIEF DESCRIPTION OF THE DRAWINGS

FIG. 1 is a schematic diagram of a system for utilizing machine learning models and/or other technologies to process, organize, and manage tangible objects and associated metadata according to embodiments of the present disclosure.

FIG. 2 illustrates exemplary input devices for marking objects for use with the system of FIG. 1 according to embodiments of the present disclosure.

FIG. 3 illustrates an exemplary graphical user interface rendered on a user device enabling selection of locations associated with objects according to embodiments of the present disclosure.

FIG. 4 illustrates an exemplary graphical user interface featuring scanning of an object in a location according to embodiments of the present disclosure.

FIG. 5 illustrates an exemplary graphical user interface featuring scanning of another object in a location according to embodiments of the present disclosure.

FIG. 6 illustrates an exemplary graphical user interface featuring detection of an object in an environment according to embodiments of the present disclosure.

FIG. 7 illustrates an exemplary graphical user interface featuring scanning of information associated with an object according to embodiments of the present disclosure.

FIG. 8 illustrates an exemplary graphical user interface featuring saving of scanned information according to embodiments of the present disclosure.

FIG. 9 illustrates an exemplary graphical user interface featuring editing of metadata and information associated with an object according to embodiments of the present disclosure.

FIG. 10 illustrates an exemplary graphical user interface featuring saved documents and historical service-related information associated with an object according to embodiments of the present disclosure.

FIG. 11 illustrates an exemplary graphical user interface featuring functionality to schedule service for an object according to embodiments of the present disclosure.

FIG. 12 illustrates an exemplary graphical user interface featuring a dashboard for an application providing functionality supporting the system of FIG. 1 according to embodiments of the present disclosure.

FIG. 13 is a flow diagram illustrating a sample method for utilizing machine learning models and/or other technologies to process, organize, and manage tangible objects and associated metadata according to embodiments of the present disclosure.

FIG. 14 is an exemplary graphical user interface to enable identification of an object or item according to embodiments of the present disclosure.

FIG. 15 is an exemplary graphical user interface to enable scanning an area for an object or item according to embodiments of the present disclosure.

FIG. 16 is an exemplary graphical user interface illustrating detection of an object in an environment according to embodiments of the present disclosure.

FIG. 17 is an exemplary graphical user interface illustrating an ability to input additional information to facilitate identification of an object according to embodiments of the present disclosure.

FIG. 18 is an exemplary graphical user interface providing an ability to select an image or content to associate with an object according to embodiments of the present disclosure.

FIG. 19 is an exemplary graphical user interface illustrating a user's spaces at a particular location according to embodiments of the present disclosure.

FIG. 20 is an exemplary graphical user interface illustrating assets at a particular location according to embodiments of the present disclosure.

FIG. 21 is an exemplary graphical user interface enabling a user to select different locations according to embodiments of the present disclosure.

FIG. 22 is an exemplary graphical user interface illustrating exemplary holographic labels utilized by embodiments of the system of the present disclosure.

FIG. 23 is an exemplary graphical user interface illustrating chat functionality provided according to embodiments of the present disclosure.

FIG. 24 is a schematic diagram of a machine in the form of a computer system within which a set of instructions, when executed, may cause the machine to facilitate utilizing machine learning models and/or other technologies to process, organize, and manage tangible objects and associated metadata according to embodiments of the present disclosure.

### DETAILED DESCRIPTION OF THE DRAWINGS

A system 100 and accompanying methods for utilizing models and other technologies to process, organize, and manage tangible objects and associated metadata are disclosed. In certain embodiments, the system 100 and methods can utilize computer vision techniques, intelligent systems, data-drive models, learning algorithms, predictive models, machine learning models, and/or other technologies, to identify, track, manage, and keep inventory of objects and/or assets in an electronic format that is convenient, reliable, and efficient. In certain embodiments, the system 100 and methods include capturing media content of an object of interest in a particular location, such as an environment. In certain embodiments, instead of capturing the media content and/or in addition to capturing the media content of the object, the system 100 and methods can scan the object in real-time. The system 100 and methods can analyze the media content taken of the object and can utilize computer vision techniques and/or machine learning models to identify the object. Once the object is identified, the system 100 and methods can determine whether the identified object matches an object corresponding to an asset of a profile of a user. If the identified object is determined to match the object corresponding to the asset of the profile of the user, the system 100 and methods can determine that the identified object is the object corresponding to the object in the profile. After determining that the identified object matches the object corresponding to the asset, the system 100 and methods can include retrieving or providing access to metadata associated with the object. In certain embodiments, the system 100 and methods can also update the metadata based on the media content and/or inputs received by the system 100.

On the other hand, if the identified object does not match an object corresponding to an asset of the profile, the system 100 and methods can classify the identified object as a new asset for inclusion in an inventory list of assets of the profile of the user. The system 100 and methods can generate metadata associated with the object, such as based on the media content and/or inputs, and can store the metadata in the profile as being associated with the new asset. Whether the object is an existing object corresponding to an asset or a new object that is a new asset, the system 100 and methods can determine whether an action needs to be performed with respect to the object. If an action associated with the object needs to be performed, the system 100 and methods can facilitate performance of the action associated with the object. The system 100 and methods can then train the machine learning models based on the media content, the metadata, the analyses, the identifications, and/or other actions conducted by the system 100 to further enhance the capabilities and performance of the machine learning models. If an action does not need to be performed with respect to the object, the system 100 and methods can proceed to directly train the machine learning models without facilitating performance of an action with respect to the object.

In certain embodiments, the system 100 and methods can provide a unified multimodal artificial intelligence system that can utilize large computer vision models that can incorporate any combinations of machine learning algorithms and/or other types of computing algorithms to facilitate the operative functionality provided by the system 100 and methods. In certain embodiments, multimodal content and/or data can include, but is not limited to, text content, image content, haptic content, audio content, video content, vibration content, sensor data, augmented reality content, virtual reality content, any type of content, or a combination thereof. In certain embodiments, the multimodal system (e.g., system 100) can process multimodal content and/or data to organize and manage tangible and/or intangible objects and metadata associated with the objects. In certain embodiments, the system 100 can be configured to understand, interpret, and/or generate response based on multiple modes of input, including, but not limited to, human-generated data, inputs based on interactions with humans and the system 100, inputs provided by robots, inputs based on interactions between robots and humans in the system 100, any other inputs, or a combination thereof.

In certain embodiments, once the system 100 processes such data, the system 100 can re-identity the data and/or the objects using the re-identification capabilities of the system 100. For example, when the system 100 captures media content and utilizes a computer vision technique to identify the object. If the system 100 is able to match the object to an object corresponding to an asset stored in a profile of the user, the system 100 effectively re-identifies the object accordingly. In certain embodiments, the system 100 can perform various techniques, such as, but not limited to, feature extraction, objects detection, image classification, visual question answering, instance segmentation, semantic segmentation, image captioning, transfer learning, fine-tuning, data augmentation, multimodal recommendations (e.g., recommendations associated with an object that are generated based on analyses of multiple types of content and/or information), multimodal anomaly detection (e.g., detecting anomalies associated with an object based on multiple types of media content and/or information), and/or other techniques to facilitate analysis of objects, identification of objects, generation of recommendations for actions to conduct with respect to objects, and/or performance of any of the other operative features and/or functionality described in the present disclosure.

In certain embodiments, the system 100 and methods can utilize algorithms to perform the operative functionality disclosed herein by utilizing algorithms that address distinct aspects of data processing of computer visional models, which result in in the system 100 delivering unparalleled efficiency and accuracy to detect and identify objects, and also process data associated with objects. In certain embodiments, the system 100 and methods can assist users in more efficiently managing and organizing objects that may be assets of the users.

In certain embodiments, the system 100 and methods can include further features and functionality. For example, the system 100 and methods can perform semantic segmentation, such as by utilizing an input device (e.g., infrared and/or ultraviolet pen) to make a mark onto an object. Semantic segmentation and/or other computer vision techniques can then be utilized to identify the mark and classify the object to be associated with the mark. In certain embodiments, the system 100 and methods can then qualify the mark in conjunction with the object to provide the mark and/or object with a unique identifier. In certain embodiments, the system 100 and methods can also convert information associated with an object (e.g., metadata) into a token or a series of tokens. In certain embodiments, the media content taken of an object can be converted and/or treated as a token by the system 100. In certain embodiments, the token can be utilized to uniquely identify an object, provide access to metadata associated with an object, store information associated with the object on a blockchain for tracking a list of assets including a plurality of objects, and/or to encrypt information associated with the object.

In certain embodiments, the system 100 can communicate with devices that are network-connected, such as those illustrated in system 100, and also with matter-enabled devices. In certain embodiments, the system 100 can communicate with the objects themselves, such as if the objects include communications devices. In certain embodiments, the system 100 can identify anomalies associated with an object by comparing data points to moving averages or rolling statistics (e.g., if a data point obtained from media content captured of an object at a current time is compared to a moving average of data points from previous occasions, a threshold deviation between the data point and the moving average can indicate presence of an anomaly). In certain embodiments, the system 100 can apply statistical techniques, such as Z-scores or percentiles to identify instances where energy consumption significantly differs from historical data (e.g., an object, such as a television, is using significantly more power than typical). In certain embodiments, the system 100 can apply thresholds for acceptable energy consumption levels (or other aspects of an object). In certain embodiments, the system 100 can utilizing computer vision models to process and integrate information from different sensory modalities, such as, but not limited to, visual (e.g., images, videos, etc.), textual (e.g., words, sentences, etc.), and/or auditory (e.g., sound, speech, etc.) inputs.

In certain embodiments, the multimodal system 100 can provide integrated processing that process and correlates data and information across different types of data (e.g., video, audio, vibration, virtual reality, haptic, etc.). As an example, the system 100 can analyze a photograph of an object and accompanying text describing features of the object to understand context more deeply than a unimodal system. In certain embodiments, the multimodal system 100 can provide for enhanced understanding capabilities. For example, by combining information from different types of sources, the system 100 can achieve a more comprehensive understanding of complex scenarios than a unimodal system. For example, in image captioning, the multimodal system 100 can generate descriptive text for an image of an object, while considering both the visual elements of the image and the relevant text. In certain embodiments, the system 100 can operate closer to how humans perceive the world, such as by integrating visual, textual, auditory and/or other types of cues to understand and interact with the environment in which the object is located. In certain embodiments, such a capability can be particularly useful when integrated with a graphical user interface that can interact with humans more naturally. In certain embodiments, the multimodal system 100 can also provide improved accessibility. For example, the system 100 can enhance accessibility, such as by providing audio descriptions for images for visually-impaired users or translating text into sign language for hearing-impaired users. In certain embodiments, the system 100 can use audio descriptions to interact with humans and the objects which are in topic.

As discussed herein, in certain embodiments, the system can store and/or recall tangible object data and information (e.g., metadata), which can be called Tangible Object Data Information (“TODI”). In certain embodiments, the system 100 can be utilized to access processed content and data, and can interact with users and machine learning models to provide information that pertains to the objects. In certain embodiments, the objects and/or information associated with the objects can be organized in lists for humans so that the lists can be stored and/or recalled, and objects can be re-identified at a future occasion. In certain embodiments, the TODI (e.g., metadata) can include, but is not limited to, size, color, shape, dimensions, life expectancy, alternate objects that are of the same size and perform in similar fashion, videos about the object, third party companies that can service, support, and repair the object, receipts and contact information from original purchase of the object, warranty information, warranty programs, service numbers, service logs and/or service history, reminders, recommendations, ability to purchase consumable items (i.e., filters), report issues, allow manufacturers of the object to receive details about the use of the object including problems, ability to list items for sale and/or sell items directly and/or indirectly, power management, power analysis, anomalous power surge, diagnostic challenge, network monitoring and/or communication. In certain embodiments, the system 100 can recall or re-identify the metadata (e.g., TODI) to assist users that own the objects to identify the metadata via the application supporting the operative functionality of the system 100. In certain embodiments, each object can be stored and organized, and metadata can be modified using machine learning models, interactions with humans, or a combination thereof.

In certain embodiments, the system 100 functionality can be operated by a robot (e.g., robot 170), robotics, machine learning models, and/or supercomputers. In certain embodiments, one or more of the foregoing can utilize the multimodal system 100 to re-identify all information obtained in the system 100 for each object and/or communicate with users accordingly. In certain embodiments, by using a robot, robotics, and/or machine learning models, the management of the system can operate autonomously without the needs for humans to obtain the data and/or recall the data associated with an object. In certain embodiments, certain aspects of the system 100 can server as a personal companion that runs artificial intelligence and can communicate with the system 100 as a whole. In certain embodiments, a robotic, robotics, and/or machine learning models can utilize natural language processing, voice assistants, and/or conversational artificial intelligence to communicate object details, manage the object, and/or provide other functionality of the system 100.

Based on at least the foregoing, the system 100 utilizes technologies that can include interacting with users to identify and manage objects in digital format by utilizing multimodal machine learning and computer vision models. The system 100 can improve quality of life by providing functionality that keeps records of objects and coverts and enhances manual processes of keeping track of objects and assets into a digital platform that enables a large set of features that can complement objects in existence at various locations. The system 100 alleviates the tedious existing techniques involving printing out and keeping object records. The system 100 also can automate service when need and can reduce the need for human interaction to provide the operative functionality provided by the system 100.

In certain embodiments, a system 100 for utilizing machine learning models and/or other technologies to process, organize, and manage tangible object and associated metadata is provided. The system 100 may include a memory that stores instructions and a processor that executes the instructions to perform various operations of the system 100. In certain embodiments, the system 100 can perform an operation that includes analyzing, by utilizing one or more machine learning models, media content associated with a first object. For example, the media content can include video content, text content, image content, audio content, audiovisual content, virtual reality content, augmented reality content, multimodal content, or a combination thereof. In certain embodiments, the system 100 can perform an operation that includes identifying the first object based on analyzing the media content using the one or more machine learning models. In certain embodiments, the one or more machine learning models can utilize any number of computer vision techniques to perform the identification. In certain embodiments, the system 100 can perform an operation that includes determining whether the at least one first object matches a second object corresponding to an asset of a plurality of assets associated with a profile, such as a profile of a user. In certain embodiments, the system 100 can perform an operation that includes determining, based on the first object being determined to match the second object, that the first object is the second object. In certain embodiments, the system can perform an operation that includes retrieving, based on the first object matching the second object, metadata associated with the second object. In certain embodiments, the system 100 can perform an operation that includes classifying, based on the first object being determined to not match the second object, the first object as a new asset for inclusion in the plurality of assets associated with the profile.

In certain embodiments, the system 100 can be configured to utilize the one or more machine learning models to perform feature extraction on the media content, conduct object detection, conduct image captioning, conduct image classification, conduct text classification, conduct audio classification, conduct video classification, or a combination thereof. In certain embodiments, the system 100 can be configured to utilize the foregoing to identify the one or more first objects. In certain embodiments, the system 100 can be configured to determine whether the one or more first objects match the one or more second objects from the profile. In certain embodiments, the system 100 can be configured to determine whether an anomaly exists for the one or more first objects by comparing the media content to the metadata, prior media content taken of the one or more first objects, activity performed by or on the one or more first objects, behavior conducted by or on the one or more first objects, one or more manufacturer specifications associated with the one or more first objects, one or more specifications specified by an owner of the one or more first objects, or a combination thereof.

In certain embodiments, the system 100 can also include an input device configured to mark the one or more first objects with a first mark to facilitate identification of the one or more first objects. In certain embodiments, the system 100 can be configured to identify the one or more first objects based on the first mark. In certain embodiments, the system 100 can include qualifying the first mark to be associated with the one or more first objects by generating a unique identifier to associated the first mark with the one or more first objects.

In certain embodiments, the system 100 can be configured to convert the media content, the metadata, or a combination thereof into a token, a series of tokens, or a combination thereof. In certain embodiments, the system 100 can be configured to train the one or more machine learning models by utilizing training data comprising training content, object specifications, manufacturer specifications, feedback relating to an accuracy of one or more determinations or predictions made by the one or more machine learning models, or a combination thereof. In certain embodiments, the system 100 can be configured to update the metadata associated with the first object (or other objects) based on information obtained from the media content. In certain embodiments, the system 100 can be configured to automatically generate content describing the one or more first objects by utilizing image captioning. In certain embodiments, the system can be configured to display the metadata associated with the one or more second objects on a user interface of a device.

In certain embodiments, the metadata associated with the one or more first objects can include sizes of the one or more first objects, shapes of the one or more first objects, dimensions of the one or more first objects, life expectancies of the one or more first objects, identification of an alternate object that serves as a substitute for the one or more first objects, repair information for the one or more first objects, warranty information for the one or more first objects, service information for the one or more first objects, one or more recommendations associated with the one or more first objects, or a combination thereof. In certain embodiments, the system can be further configured to capture the media content associated with the one or more first objects by utilizing a camera, a sensor, a computing device, or a combination thereof. In certain embodiments, the system can be configured to organize the plurality of assets within the profile and according to one or more criteria.

In certain embodiments, a method for utilizing machine learning models and/or other technologies to process, organize, and manage tangible object and associated metadata is disclosed. The method may include a memory that stores instructions and a processor that executes the instructions to perform the functionality of the method. In certain embodiments, the method can be performed by utilizing the system 100 and/or other systems. In certain embodiments, the method can include analyzing, by utilizing one or more machine learning models, media content associated with a first object. In certain embodiments, the method can include identifying the first object based on analyzing the media content and by utilizing one or more computer vision techniques utilized by the one or more machine learning models. In certain embodiments, the method can include determining whether the first object matches a second object corresponding to an asset of a plurality of assets associated with a profile. In certain embodiments, the method can include determining, based on the first object matching the second object, that the first object is the second object. In certain embodiments, the method can include obtaining, based on the first object matching the second object, metadata associated with the second object. In certain embodiments, the method can include classifying, based on the first object being determined to not match the second object, the first object as a new asset for inclusion in the plurality of assets associated with the profile.

In certain embodiments, the method can include determining a condition associated with the first object based on utilizing the one or more machine learning models to analyze the media content associated with the first object. In certain embodiments, the method can include generating the metadata based on analyzing the media content, based on a manual input by a user, based on a signal from one or more other objects, or a combination thereof. In certain embodiments, the method can include marking the first object by utilizing an infrared pen, an ultraviolet pen, or a combination thereof. In certain embodiments, the method can include utilizing semantic segmentation to perform the marking of the first object. In certain embodiments, the method can include determining whether the first object needs to be repaired, replaced, modified, maintained, or a combination thereof, based on the analyzing of the media content.

In certain embodiments, a computer-readable device comprising instructions, which, when loaded and executed by a processor cause the processor to be configured to: analyze, by utilizing at least one machine learning model media content associated with at least one first object; identify the at least one first object based on analyzing the media content and by utilizing at least one computer vision technique utilized by the at least one machine learning model; determine whether the at least one first object matches at least one second object corresponding to an asset of a plurality of assets associated with a profile; determine, based on the at least one first object being determined to match the at least one second object, that the at least one first object is the at least one second object; retrieve, based on the at least one first object matching the at least one second object, metadata associated with the at least one second object; and classify, based on the at least one first object being determined to not match the at least one second object, the at least one first object as a new asset for inclusion in the plurality of assets associated with the profile.

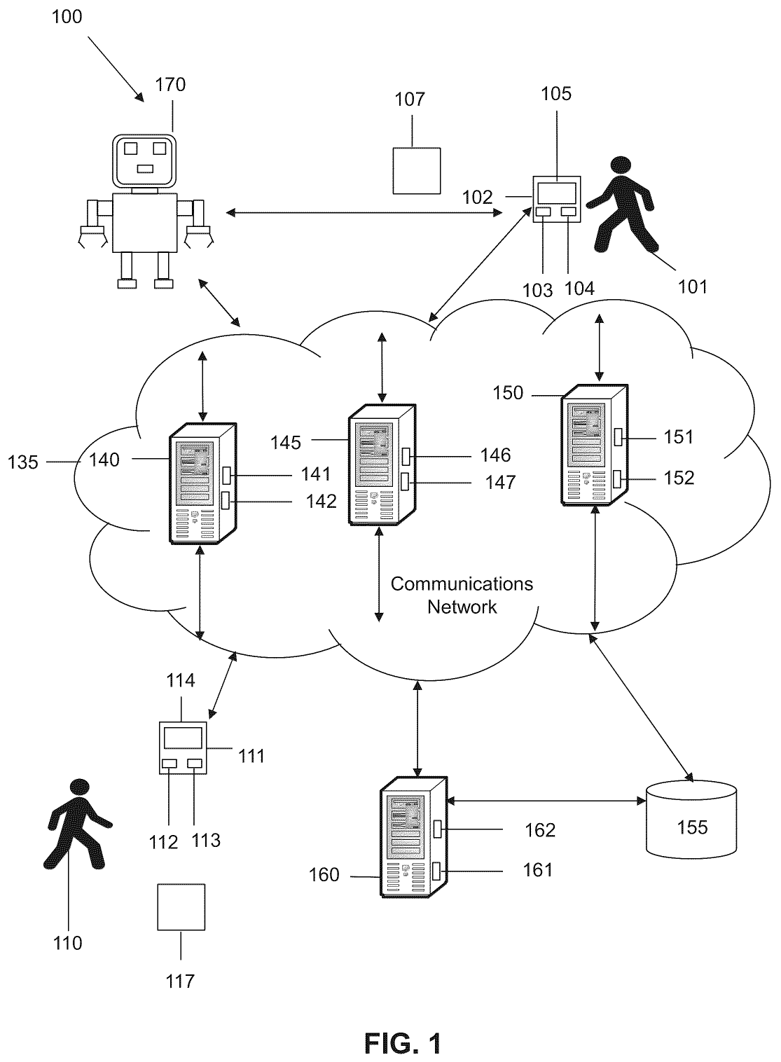

As shown in FIG. 1, a system for utilizing machine learning models and/or other technologies to process, organize, and manage tangible object and associated metadata according to embodiments of the present disclosure is disclosed. Notably, the system 100 may be configured to support, but is not limited to supporting, inventory management systems, asset management systems, object detection and classification systems, data analytics systems and services, data collation and processing systems and services, artificial intelligence services and systems, machine learning services and systems, content delivery services, cloud computing services, satellite services, telephone services, voice-over-internet protocol services (VOIP), software as a service (SaaS) applications, platform as a service (PaaS) applications, social media applications and services, operations management applications and services, productivity applications and services, mobile applications and services, and/or any other computing applications and services. Notably, the system 100 may include a first user 101, who may utilize a first user device 102 to access data, content, and services, or to perform a variety of other tasks and functions. As an example, the first user 101 may utilize first user device 102 to transmit signals to access various online services and content, such as those available on an internet, on other devices, and/or on various computing systems. As another example, the first user device 102 may be utilized by the first user 101 to access an application, devices, and/or components of the system 100 that provide any or all of the operative functions of the system 100. For example, the first user 101 may utilize the first user device 102 to access an application having a user interface that enables the first user 101 to scan objects in an environment, capture media content of the objects, detect the objects, identify the objects, generate information about the objects (e.g., metadata), store the information in profiles for the first user 101 (e.g., an inventory of assets scanned and/or detected by the system 100), redetect the objects, perform actions on and/or associated with the objects, perform any other operative functionality, or a combination thereof. In certain embodiments, the first user 101 may be a bystander, any type of person, a robot, a humanoid, a program, a computer, any type of user, or a combination thereof, that may be located in a particular environment, such as a home.

In certain embodiments, the first user 101 may be a person that may be seeking to create an inventory of objects (e.g., personal assets) at the person's home, office, and/or other locations. For example, the first user 101 may want to track the statuses of each of the first user 101 assets at the user's home, such as, but not limited to, the first user's 101 refrigerator, television, oven, microwave, jewelry, sofa, bed, computers, any other objects, or a combination thereof. The first user 101 may want to track the statuses of each of the objects to determine when to maintain them, repair them, replace them, or perform other actions with regard to the objects in an optimized and non-tedious fashion. In certain embodiments, the first user device 102 may be utilized by the first user to interact with the system 100, other users of the system 100, or a combination thereof. In certain embodiments, the first user device 102 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, etc.) that may enable the first user 101 to interact with various applications executing on the first user device 102 and to interact with the system 100. In certain embodiments, the first user device 102 may be and/or may include a computer, any type of sensor, a laptop, a set-top-box, a tablet device, a phablet, a server, a mobile device, a smartphone, a smart watch, and/or any other type of computing device. Illustratively, the first user device 102 is shown as a smartphone device in FIG. 1. In certain embodiments, the first user device 102 may be utilized by the first user 101 to control and/or provide some or all of the operative functionality of the system 100.

In addition to using first user device 102, the first user 101 may also utilize and/or have access to additional user devices. As with first user device 102, the first user 101 may utilize the additional user devices to transmit signals to access various online services and content and/or to perform the operative functionality of the system 100. The additional user devices may include memories that include instructions, and processors that executes the instructions from the memories to perform the various operations that are performed by the additional user devices. In certain embodiments, the processors of the additional user devices may be hardware, software, or a combination thereof. The additional user devices may also include interfaces that may enable the first user 101 to interact with various applications executing on the additional user devices and to interact with the system 100. In certain embodiments, the first user device 102 and/or the additional user devices may be and/or may include a computer, any type of sensor, a laptop, a set-top-box, a tablet device, a phablet, a server, a mobile device, a smartphone, a smart watch, a camera, and/or any other type of computing device, and/or any combination thereof. Sensors may include, but are not limited to, cameras, motion sensors, acoustic/audio sensors, pressure sensors, temperature sensors, light sensors, heart-rate sensors, blood pressure sensors, sweat detection sensors, eye-tracking sensors, breath-detection sensors, stress-detection sensors, any type of health sensor, humidity sensors, any type of sensors, or a combination thereof.

The first user device 102 and/or additional user devices may belong to and/or form a communications network. In certain embodiments, the communications network may be a local, mesh, or other network that enables and/or facilitates various aspects of the functionality of the system 100. In certain embodiments, the communications network may be formed between the first user device 102 and additional user devices through the use of any type of wireless or other protocol and/or technology. For example, user devices may communicate with one another in the communications network by utilizing any protocol and/or wireless technology, satellite, fiber, or any combination thereof. Notably, the communications network may be configured to communicatively link with and/or communicate with any other network of the system 100 and/or outside the system 100.

In certain embodiments, the first user device 102 and additional user devices belonging to the communications network may share and exchange data with each other via the communications network. For example, the user devices may share information associated with the users of the user devices, information identifying objects detected in environments that the users are located in, metadata associated with the identified objects from the environments, information indicating a condition of the identified objects, information indicating whether a detected object needs to be repaired, maintained, and/or replaced, information indicating a type of the identified object, information identifying characteristics of the identified object (e.g., shape, size, dimensions, age, components, etc.), information indicating whether a detected object matches an object stored in a user profile of a user, information identifying user profiles for users of the user devices, information identifying device profiles for the user devices, information identifying the number of devices in the communications network, information identifying devices being added to or removed from the communications network, any other information, or any combination thereof.

In addition to the first user 101, the system 100 may also include a second user 110. In certain embodiments, the second user 110 may also be a user that may want to track objects belonging to the second user 110 or other objects that are of interest to the second user 110. In certain embodiments, the second user device 111 may be utilized by the second user 110 to transmit signals to request various types of content, services, and data provided by and/or accessible by communications network 135 or any other network in the system 100. In certain embodiments, the second user device 111 may be utilized by the second user 110 to scan objects, detect objects, identify objects, generate metadata about the objects, capture media content of the objects, store information about the objects in a user profile of the second user 110, schedule repairs or maintenance for objects, perceive information about the objects and/or media content captured of the object, perform any other actions, or a combination thereof. In further embodiments, the second user 110 may be a robot, a computer, a vehicle (e.g. semi or fully-automated vehicle), a humanoid, an animal, any type of user, or any combination thereof. The second user device 111 may include a memory 112 that includes instructions, and a processor 113 that executes the instructions from the memory 112 to perform the various operations that are performed by the second user device 111. In certain embodiments, the processor 113 may be hardware, software, or a combination thereof. The second user device 111 may also include an interface 114 (e.g. screen, monitor, graphical user interface, etc.) that may enable the first user 101 to interact with various applications executing on the second user device 111 and, in certain embodiments, to interact with the system 100. In certain embodiments, the second user device 111 may be a computer, a laptop, a set-top-box, a tablet device, a phablet, a server, a mobile device, a smartphone, a smart watch, and/or any other type of computing device. Illustratively, the second user device 111 is shown as a mobile device in FIG. 1. In certain embodiments, the second user device 111 may also include sensors, such as, but are not limited to, cameras, audio sensors, motion sensors, pressure sensors, temperature sensors, light sensors, heart-rate sensors, blood pressure sensors, sweat detection sensors, breath-detection sensors, eye-tracking sensors, stress-detection sensors, any type of health sensor, humidity sensors, any type of sensors, or a combination thereof.

In certain embodiments, the first user device 102, the additional user devices, and/or the second user device 111 may have any number of software applications and/or application services stored and/or accessible thereon. For example, the first user device 102, the additional user devices, and/or the second user device 111 may include applications for controlling and/or accessing the operative features and functionality of the system 100, applications for controlling and/or accessing any device of the system 100, applications for conducting object, inventory, and/or asset management, applications for conducting object classification and/or detection (e.g., machine learning applications), interactive social media applications, biometric applications, cloud-based applications, VOIP applications, other types of phone-based applications, product-ordering applications, business applications, e-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications may support the functionality provided by the system 100 and methods described in the present disclosure. In certain embodiments, the software applications and services may include one or more graphical user interfaces so as to enable the first and/or potentially second users 101, 110 to readily interact with the software applications. The software applications and services may also be utilized by the first and/or potentially second users 101, 110 to interact with any device in the system 100, any network in the system 100, or any combination thereof. In certain embodiments, the first user device 102, the additional user devices, and/or potentially the second user device 111 may include associated telephone numbers, device identities, or any other identifiers to uniquely identify the first user device 102, the additional user devices, and/or the second user device 111.

The system 100 may also include a communications network 135. The communications network 135 may be under the control of a service provider, any designated user, a computer, another network, or a combination thereof. The communications network 135 of the system 100 may be configured to link each of the devices in the system 100 to one another. For example, the communications network 135 may be utilized by the first user device 102 to connect with other devices within or outside communications network 135. Additionally, the communications network 135 may be configured to transmit, generate, and receive any information and data traversing the system 100. In certain embodiments, the communications network 135 may include any number of servers, databases, or other componentry. The communications network 135 may also include and be connected to a mesh network, a local network, a cloud-computing network, an IMS network, a VoIP network, a security network, a VOLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 140, 145, and 150 are shown as being included within communications network 135. In certain embodiments, the communications network 135 may be part of a single autonomous system that is located in a particular geographic region or be part of multiple autonomous systems that span several geographic regions.

Notably, the functionality of the system 100 may be supported and executed by using any combination of the servers 140, 145, 150, and 160. The servers 140, 145, and 150 may reside in communications network 135, however, in certain embodiments, the servers 140, 145, 150 may reside outside communications network 135. The servers 140, 145, and 150 may provide and serve as a server service that performs the various operations and functions provided by the system 100. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 145 may include a memory 146 that includes instructions, and a processor 147 that executes the instructions from the memory 146 to perform the various operations that are performed by the server 145. Furthermore, the server 150 may include a memory 151 that includes instructions, and a processor 152 that executes the instructions from the memory 151 to perform the various operations that are performed by the server 150. In certain embodiments, the servers 140, 145, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 145, 150 may be communicatively linked to the communications network 135, any network, any device in the system 100, or any combination thereof.

The database 155 of the system 100 may be utilized to store and relay information that traverses the system 100, cache content that traverses the system 100, store data about each of the devices in the system 100 and perform any other typical functions of a database. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or may be connected to a processor and memory to perform the various operation associated with the database 155. In certain embodiments, the database 155 may be connected to the servers 140, 145, 150, 160, the first user device 102, the second user device 111, the additional user devices, any devices in the system 100, any process of the system 100, any program of the system 100, any other device, any network, or any combination thereof.

The database 155 may also store information and metadata obtained from the system 100, store metadata and other information associated with the first and second users 101, 110, store machine learning models utilized in the system 100, store sensor data and/or media content associated with objects, store histories associated with tracking objects, store metadata generated by the machine learning models based on media content and/or sensor data, store predictions made by the system 100 and/or machine learning models, storing confidence/accuracy scores relating to predictions made, store threshold/accuracy values for confidence scores, responses outputted and/or facilitated by the system 100, store information associated with anything determined or detected via the system 100, store information and/or content utilized to train the machine learning models, store information associated with behaviors and/or actions conducted one or to the objects, store user profiles associated with the first and second users 101, 110, store any number of assets and metadata in the user profiles, store device profiles associated with any device in the system 100, store communications traversing the system 100, store user preferences, store information associated with any device or signal in the system 100, store information relating to patterns of usage relating to the user devices 102, 111, store any information obtained from any of the networks in the system 100, store historical data associated with the first and second users 101, 110, store device characteristics, store information relating to any devices associated with the first and second users 101, 110, store information associated with the communications network 135, store markings made by input devices of the system 100, store any information generated and/or processed by the system 100, store any of the information disclosed for any of the operations and functions disclosed for the system 100 herewith, store any information traversing the system 100, or any combination thereof. In certain embodiments, the database 155 can store any number and/or type of machine learning algorithms including, but not limited to, computer vision algorithms, other types of algorithms, or a combination thereof. Furthermore, the database 155 may be configured to process queries sent to it by any device in the system 100.

In certain embodiments, the system 100 can incorporate the use of any number of artificial intelligence and/or machine learning engines that can include one or more artificial intelligence and/or machine learning models supporting the functionality of the system 100. In certain embodiments, an artificial intelligence and/or machine learning model can be a file, program, module, and/or process that can be trained by the system 100 (or other system) to recognize certain patterns, content, marks, characteristics, and/or other features of objects that can be located in an environment. For example, the artificial intelligence and/or machine learning model(s) can be trained to interact with a user (e.g., first user 101 and/or second user 110) via graphical user interfaces of applications utilizing the model(s), obtain information from the user, detect objects in an environment, identify the objects (e.g., based on comparing information contained in media content taken of an object to a profile of a user that can include a list of assets corresponding to previously saved objects), recommend actions to perform with respect to objects, and/or perform any of the operative functionality of the system 100. In certain embodiments, the functionality and features provided by the system 100 and methods can be facilitated and/or provided by learning algorithms, deep learning algorithms and systems, neural networks, data-driven models, intelligent systems, predictive models, any other types of algorithms and models, or a combination thereof. In certain embodiments, for example, the artificial intelligence model can be, can include, and/or may utilize a Deep Convolutional Neural Network, a one-dimensional convolutional neural network, a two-dimensional convolutional neural network, a Long Short-Term Memory network, vision transformers, any type of machine learning system, any type of artificial intelligence system, or a combination thereof. Additionally, in certain embodiments, the artificial intelligence and/or machine learning models can incorporate the use of any type of artificial intelligence and/or machine learning algorithms to facilitate the operation of the artificial intelligence model(s).

In certain embodiments, the system 100 can train the artificial intelligence model(s) and/or machine learning model(s) to reason and learn from data fed into the system 100 so that the model(s) can generate and/or facilitate the generation of predictions about new data and information that is fed into the system 100 for analysis. For example, the system 100 can train an artificial intelligence and/or machine learning model using various types of data, information, and/or content, such as, but not limited to, images, video content, audio content, text content, augmented reality content, virtual reality content, information relating to patterns, information relating to behaviors of objects and/or behaviors of objects that interact with objects, information relating to characteristics of objects, information relating to interactions between users and objects, information relating to environments, sensor data, any data associated with the foregoing, any type of data, or a combination thereof. In certain embodiments, the content and/or data utilized to train the artificial intelligence and/or machine learning models can be utilized to enhance identification, analysis, and recommendation capabilities of the models over time. As additional data and/or content is fed into the model(s) over time, the model's ability to recognize objects, identify objects, generate metadata associated with objects, generate recommendations for actions to perform with respect to objects, and/or perform other functionality as described in the present disclosure will improve and be more finely tuned. Additionally, the artificial intelligence and/or machine learning model's ability to interact with users and obtain more relevant information from users, such as by an application of the system 100 can also be enhanced.

In certain embodiments, the system 100 can also include any number of robots 170. In certain embodiments, the robots can include any type of components of existing robots, and can include components including, but not limited to, processors, memories, sensors, cameras, wheels, robotic arms, robotic legs to facilitate motion or movement, robotic hands to grasp, release, repair, or replace objects, communication systems, any other components, or a combination thereof. In certain embodiments, the robot 170 can be configured to receive or transmit signals from or to any device of the system 100 and/or system 1400. In certain embodiments, the robot 170 can receive signals including instructions to perform actions with respect to objects in an environment (e.g., to repair, replace, move, manipulate, transport, maintain, or perform another action with respect to the object). In certain embodiments, the robot 170 can include software that controls the operative functionality of the robot 170 and can also include any number or type of machine learning models. In certain embodiments, the operative functions and capabilities of the robot 170 can continuously improve over time via the learning of the machine learning models that are facilitating the operative functionality and capabilities of the robot 170.

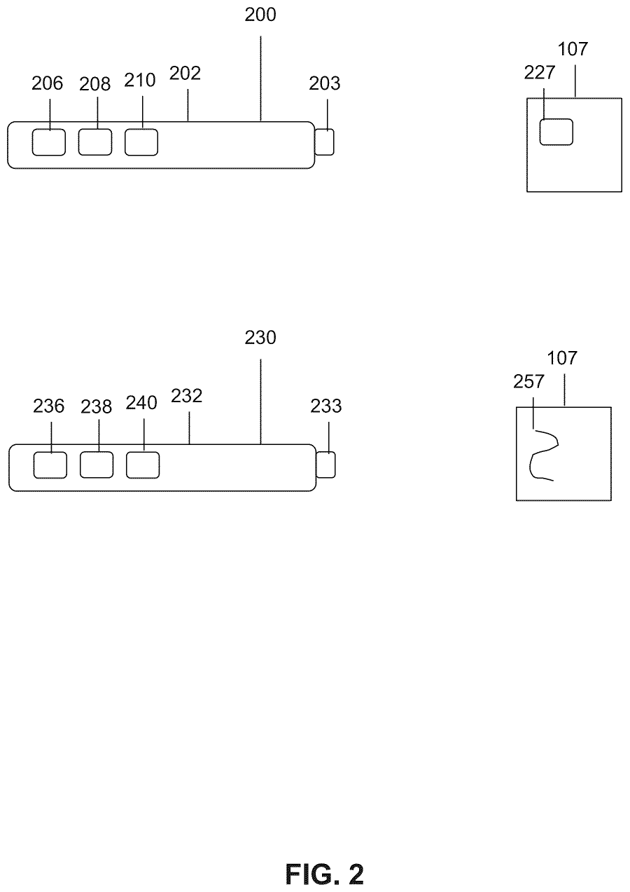

Referring now also to FIG. 2, exemplary input devices 200, 230 for marking objects for facilitating identification and tracking of objects using the system 100 are provided. In certain embodiments, the input devices 200, 230 can be any type of input device that can be utilized by the first and second users 101, 110 to mark objects so that the objects can be identified and tracked. In certain embodiments, input device 200 can be an infrared pen and input device 230 can be an ultraviolet pen. In certain embodiments, the input device 200 can include an infrared LED 203 (e.g., that emits infrared light), a body 202, a power source 206 (e.g., a battery), a switch 208 (e.g., to activate or deactivate the infrared pen), and components 210. In certain embodiments, the components 210 can be infrared filters (e.g., to focus the emitted light and/or improve its detection by sensors positioned on the object 107), processors, memories, communication modules (e.g., wireless chip, Bluetooth, etc.), any other types of components, or a combination thereof. In certain embodiments, the first user 101 can activate the infrared pen by pressing on the switch 208 and can direct the infrared light emitted by the infrared LED 203 towards the surface of an object 107. In certain embodiments, one or more sensors 227 (e.g., infrared sensors) that are positioned on the object can detect the infrared light and can determine the position of the infrared pen based on the detected infrared light. The sensors 227 can track the infrared pen's movements and can determine a specific pattern utilized to mark the object 107. The sensors 227 can share the pattern with the first user's 101 first user device 102, which can save the pattern and associate the pattern with the object 107. In certain embodiments, metadata associated with the object can also be saved with the pattern. In certain embodiments, the first user 101 can write information (e.g., information indicating characteristics and/or a condition of the object) about the object 107 onto the surface of the object 107 using the infrared light, which can be detected by the first user device 102, such as via a camera of the first user device 102 and/or sensors of the first user device 102. In certain embodiments, the pattern can be re-detected on a later occasion, such as when the first user 101 creates the pattern again on the object at the later occasion. When the first user device 102 detects the pattern, the system 100 can automatically provide the metadata associated with the object.

In certain embodiments, input device 230 (e.g., ultraviolet pen) can include an ultraviolet LED 233, a body 232, a power source 236, a switch 238, an ultraviolet filter 240, and/or other components. In certain embodiments, the object 107 can be marked with a specific pattern 257, such as by utilizing a fluorescent or phosphorescent marker or substance (or other ultraviolet LED detectable marker or substance). In certain embodiments, after the object 107 has been marked with a specific pattern 257, the first user 101 can activate the input device 230 by utilizing the switch 238. The ultraviolet light emitted by the ultraviolet LED 233 can reveal the marking 257 and the ultraviolet filter 240 can help to focus the emitted ultraviolet light. The first user device 102 can detect the marking 257, which can be associated with the object 107 and can be utilized to retrieve metadata associated with the object 107 that is stored in the system 100. On future occasions, the marking 257 can be detected again and the metadata associated with the object 107 can be updated.

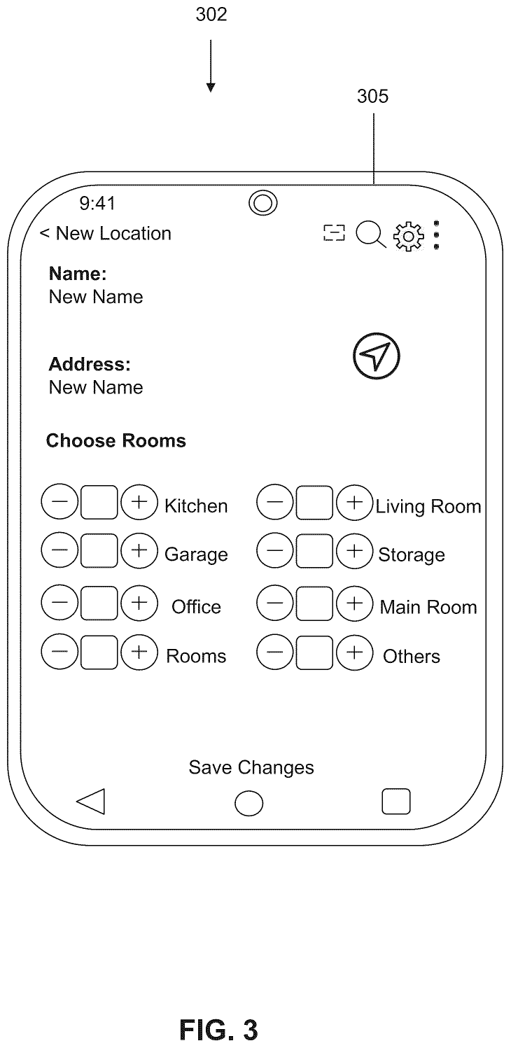

Operatively, the system 100 may operate and/or execute the functionality as described and illustrated in FIGS. 1-14 or as otherwise described herein. Notably, the system 100 can operate under various use-case scenarios. In an exemplary use-case scenario, a first user 101 can launch an application supporting the functionality of the system 100, such as via first user device 102. Once the application is launched, a user interface for the application can be rendered to the user and various controls for controlling the various functionality and features of the system 100 can be displayed or otherwise provided. In certain embodiments, for example, the application can enable the first user 101 to select a particular location at which the first user 101 may want to track objects, such as for inclusion in a list of assets stored in a user profile of the first user 101 that is stored via the application. Referring now also to FIG. 3, an exemplary user device 302 (e.g., can be first user device 102 or second user device 110) is shown. The exemplary user device 302 can render the user interface 305 of the application supporting the functionality of the system 100. In certain embodiments, the user interface 305 can enable the first user 101 to select a name for the location, an address for the location, obtain GPS coordinates for the location (e.g., by utilizing location services provided by a GPS sensor of the user device 302), and selecting rooms within the location to scan, track, and/or manage objects as assets of the first user 101. In certain embodiments, once the rooms are selected within the location, the first user 101 can save the first user's 101 inputs, which can be saved to a profile associated with the user that can be utilized to store information associated with objects at the location.

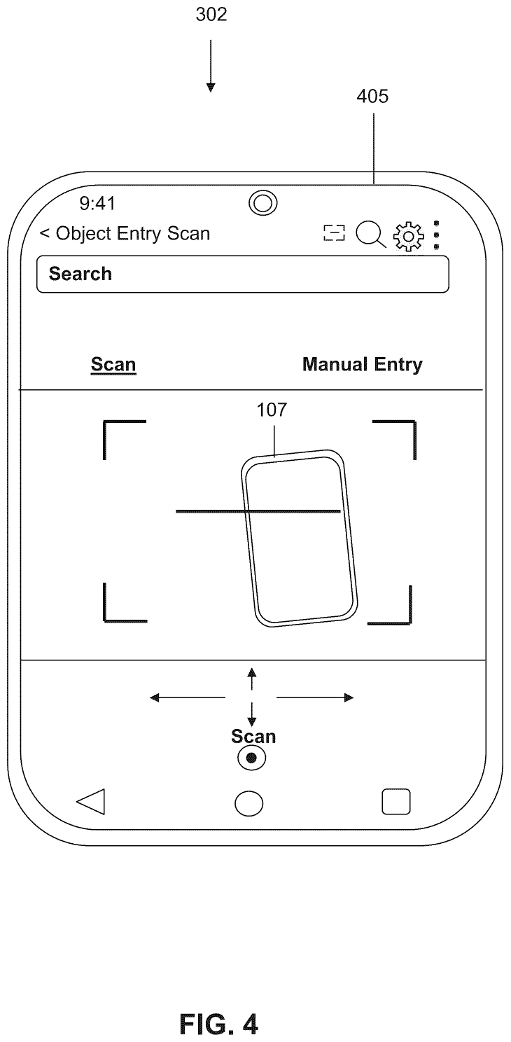

Referring now also to FIG. 4, once the first user 101 selects the rooms for which the first user 101 wants to scan, track, and/or manage objects, the first user 101 can be presented with user interface 405. In certain embodiments, user interface 405 can activate cameras and/or other sensors of the user device to capture media content of one or more locations (e.g., environments) and/or one or more objects at the one or more locations. For example, as shown in FIG. 4, the camera and/or sensors of the user device 103 can be activated and the location can be the first user's 101 kitchen. As shown in the viewing window of the camera of the user device 103, the object can be a kitchen mat that the first user 101 may want to track as an asset in the first user's 101 profile that is stored via the application executing on the user device 302. In certain embodiments, the first user 101 can tap on the scan digital button to start capturing media content of the object, however, in certain embodiments, the user device 302 can start capturing media content of the object as soon as the object is within the viewing window of the camera. In certain embodiments, various sensors, such as, but not limited to, light sensors, pressure sensors, temperature sensors, motion sensors (e.g., accelerometers), orientation sensors (e.g., gyroscopes), vibration sensors, and/or any other types of sensors can also capture and/or measure sensor data associated with the object and/or location in which the object resides. In certain embodiments, the application can provide the option to the first user 101 to enter information manually via the application to describe the object. In certain embodiments, the application itself can initiate analysis of the media content to determine and/or identify the type of object and generate metadata to describe the characteristics of the object. In certain embodiments, the application can enable the first user 101 to capture media content at various angles, positions, and/or can enable the first user 101 to zoom in and zoom out with respect to the object. In certain embodiments, the graphical user interface 405 can enable the first user 101 to search for the first user's 101 asset list and any objects currently saved in the first user's 101 profile.

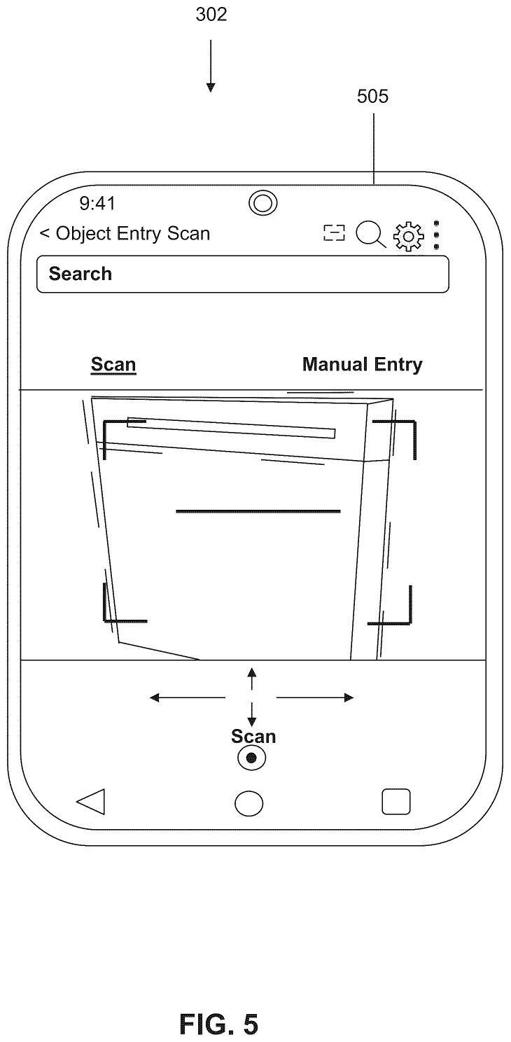

Referring now also to FIG. 5, the first user 101 can opt to scan another object either in the same location or a different location. The graphical user interface 505 can be displayed and the camera and/or sensors to capture media content and/or sensor data associated with the object. Illustratively, the object is shown as a dishwasher. In certain embodiments, the application analyzes and identifies the object, such as by utilizing a machine learning model(s) and/or computer vision techniques. In certain embodiments, the application can generate metadata associated with the object, such as, but not limited to, metadata indicating the colors of the object, the condition of the object, the dimensions of the object, information indicating whether the object is operating or not, information relating to the components of the object, information indicating a price of the object, any other information, or a combination thereof. In certain embodiments, the application can enable the first user 101 to manually enter in a custom description associated with the object as well.

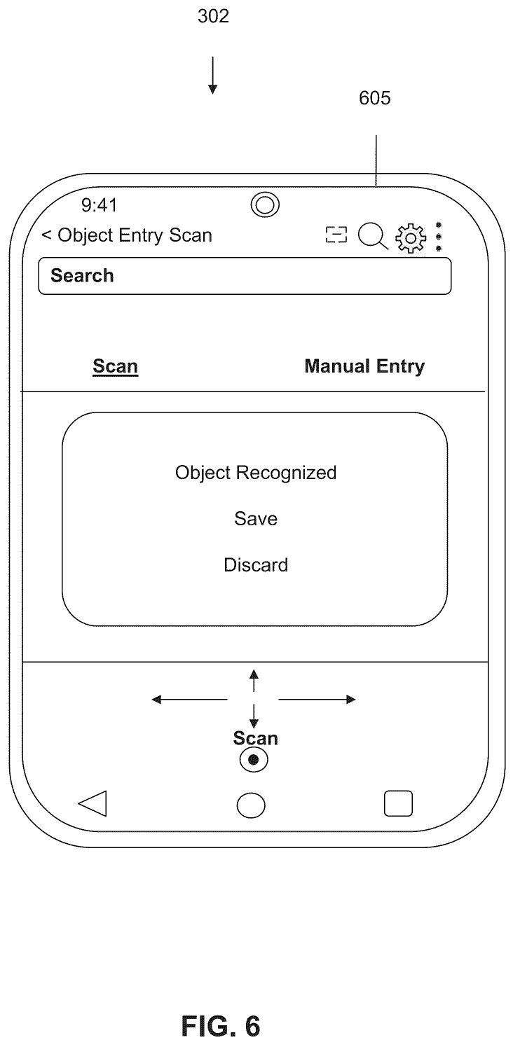

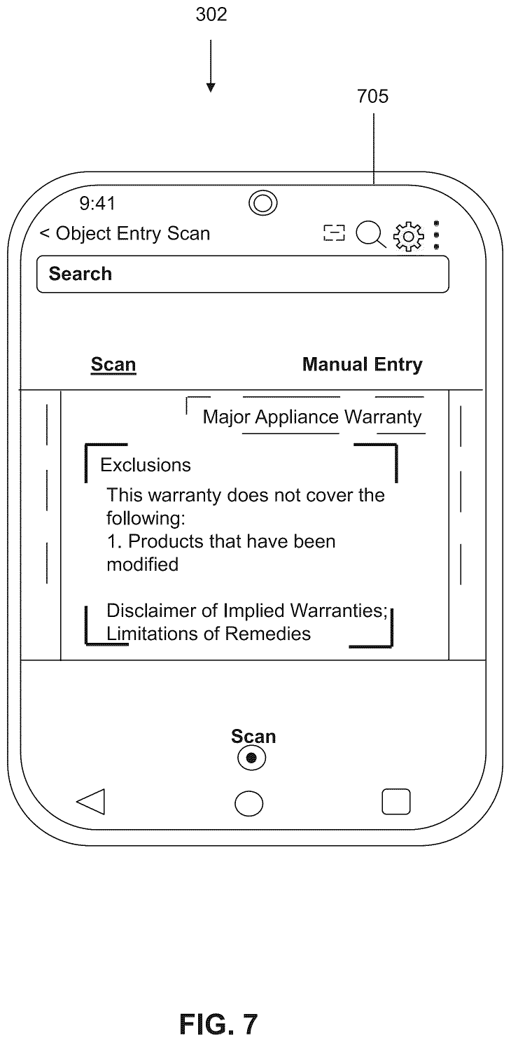

Referring now also to FIG. 6, a graphical user interface 605 can be rendered for the first user 101. For example, once the application of the system 100 analyzes and identifies the object, the application can output a notification indicating that the object has been recognized. In certain embodiments, the application can enable the first user 101 to save or discard the media content, the analysis, and/or the determination made by the application of the system 100. Referring now also to FIG. 7, a graphical user interface 705 that enables the first user 101 to capture media content, sensor data, or a combination thereof of warranty information associated with the object. For example, the application can detect restrictions on the warranty for one or more of the objects based on analyzing the text of the warranty information, such as by utilizing natural language processing and/or other techniques for analyzing the information. In certain embodiments, the information obtained via the scanning can be saved in the profile for the object that is stored on the first user device 102. In certain embodiments, the system 100 can utilize the warranty information to determine whether a certain condition of the object is covered under the warranty and can automatically schedule an appointment to repair, maintain, and/or replace a component of the object based on the warranty. In certain embodiments, the application (e.g., metadata associated with the warranty for the object and/or the object itself) can also enable the first user 101 to enter in information associated with the warranty via manual entry using the application.

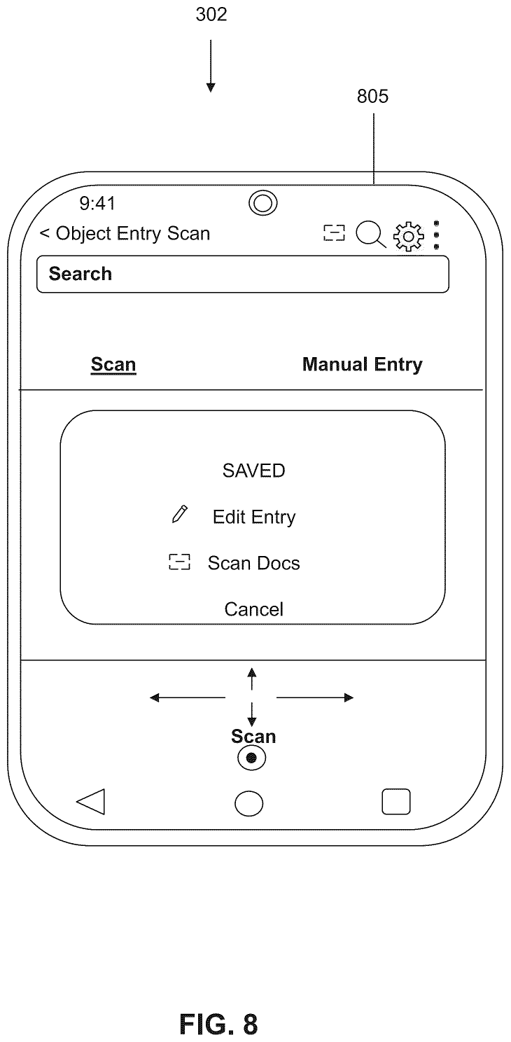

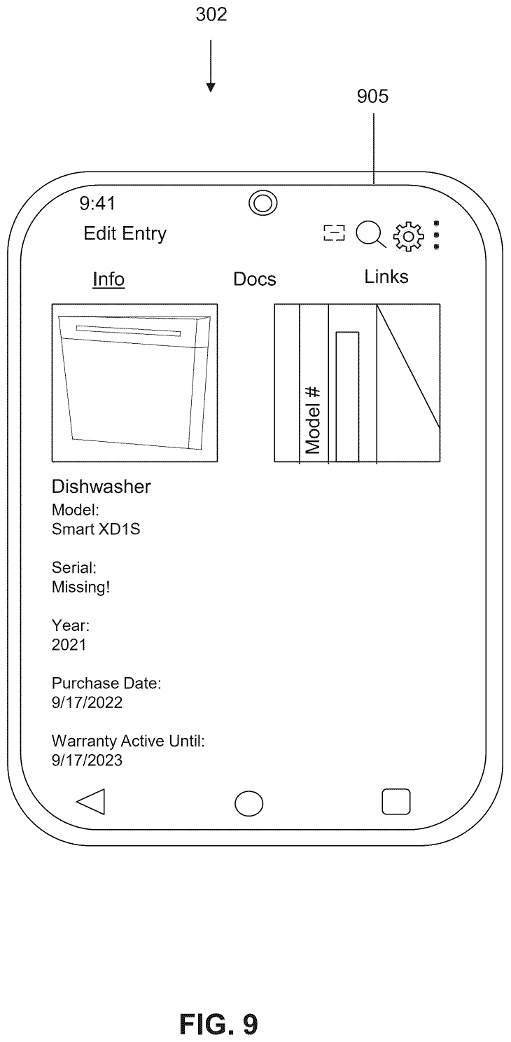

Referring now also to FIG. 8, a graphical user interface 805 for the application that enables additional functionality is provided. In certain embodiments, the graphical user interface 805 can be utilized to indicate that media content taken of the object has been saved in the system 100. In certain embodiments, the controls for the application of the system 100 can also include the ability to enable the first user 101 to edit information and/or metadata associated with the object and to scan additional objects at the same location and/or at other locations. Referring now also to FIG. 9, a graphical user interface 905 is provided that enables the first user 101 to view information and/or metadata associated with an object, such as an object that corresponds to an asset of a plurality of assets. As an example, if the media content taken by the user device 302 was of the dishwasher, the media content including the dishwasher can be displayed via the user interface 905. In addition to providing the media content, application can also provide information relating to the object for display on the user interface 905. For example, for the dishwasher, the user interface 905 can display the model number, the serial number, the year the dishwasher was made, the purchase date, the date that the warranty expires, components of the dishwasher, repair dates for the dishwasher, scheduled maintenance dates, related objects, any other information, or a combination thereof. In certain embodiments, the application can enable the first user 101 to edit the information associated with the object. For example, in FIG. 9, the serial number is missing and the first user 101 can be enabled to input the serial number in such as via an editing control of the application.

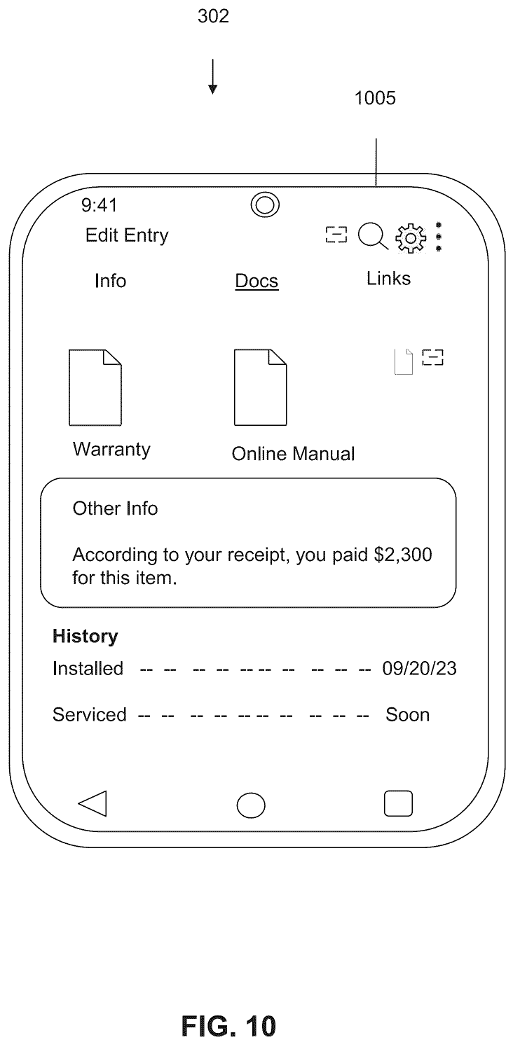

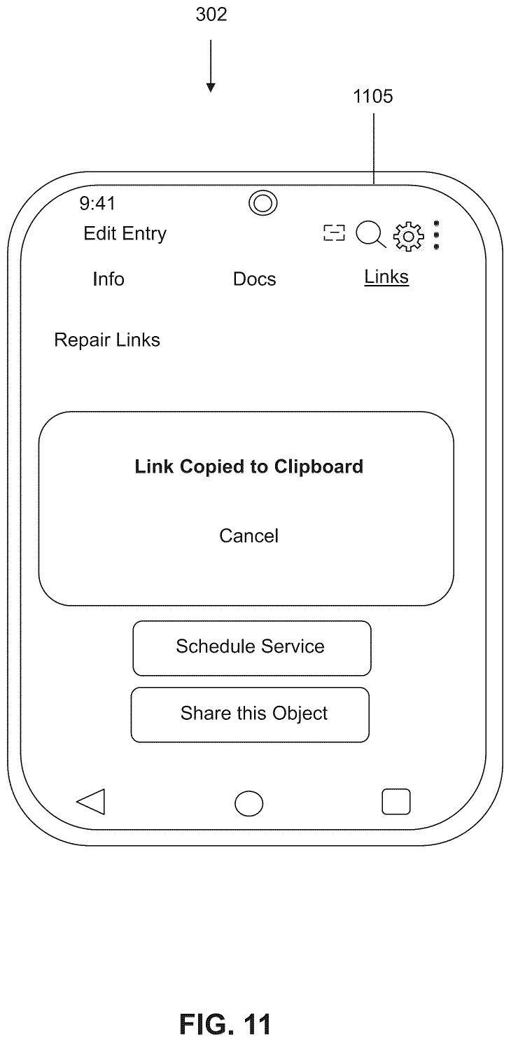

Referring now also to FIG. 10, a graphical user interface 1005 for the application that enables the first user 101 to view and interact with documents associated with an object is provided. For example, the application can make accessible the warranty documentation, an online manual for operating the dishwasher, information indicating the amount paid for the dishwasher, an indication of a date of installation for the dishwasher, a next service date for the dishwasher, a history of the dishwasher, any other information, or a combination thereof. In certain embodiments, the application can also enable the first user 101 to upload documentation related to the object, such as via an upload function of the application. In certain embodiments, the application itself can automatically scan and upload documents, such as by utilizing a camera of the user device 302. Referring now also to FIG. 11, a graphical user interface 1105 is shown, which enables a user to access a variety of links that can be utilized to perform actions with respect to an object, such as an object that corresponds to an asset of the first user 101. In certain embodiments, for example, the first user 101 can click on a navigation element entitled links to access links associated with the object. Exemplary links can include a link to schedule a service for the object, a link to share the object with another user (e.g., second user 110), a link to connect with a manufacturer of the object, any other links, or a combination thereof. In certain embodiments, the application can enable the first user 101 to copy links to a digital clipboard, which can be saved and/or accessed by the first user 101.

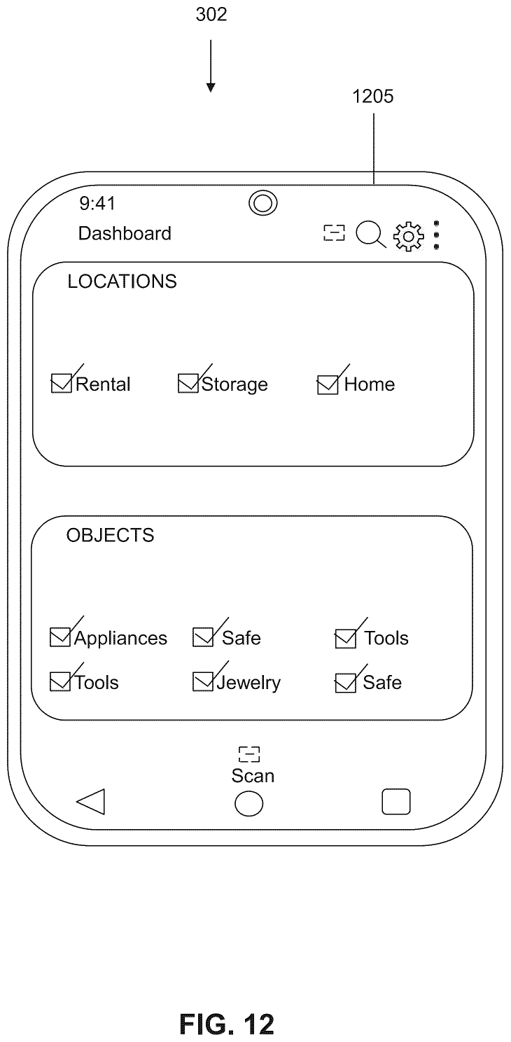

Referring now also to FIG. 12, a graphical user interface 1205 illustrating an exemplary dashboard for the application supporting the functionality of the system 100 is provided. For example, illustratively, the graphical user interface 1205 enables the first user 101 to select or deselect various locations that can include objects. In certain embodiments, objects scanned, analyzed, and/or identified by the application of the system 100 can be stored in a list(s) of assets for the first user 101. In certain embodiments, the list of assets can include information identifying each object and also the specific location at which the object is located or was most recently located. Illustratively, as shown in FIG. 12, the first user 101 can have a Rental location, a Storage location, and a Home location. The first user 101 can select each location that they want to view corresponding objects located at each location. The user interface 1205 can also enable the user to select the specific types of objects at each location that the user wants to view information about, modify information about, and/or perform other actions with respect to such objects. Notably, the application can include and/or incorporate any of the functionality of the system 100, the methods described herein, or a combination thereof.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, capturing media content associated with an object in an environment (and/or sensor data associated with the object); analyzing the media content and/or sensor data, such as by utilizing a machine learning model(s); identifying objects based on analyzing the media content and/or sensor data; determining whether the identified object matches an object corresponding to an asset of a plurality of assets of a profile of a user; retrieving metadata associated with the object if the object matches an object corresponding to an asset of a profile of the user; updating the metadata associated with the object; classifying the object as a new asset for inclusion in the profile if the object does not match an object corresponding to an asset in the profile; generating metadata for the new asset/object; determining whether an action needs to be performed with respect to the object; performing the action with respect to the object; training the machine learning model (e.g., based on the accuracy of the identifying of the objects and matching the objects to assets in the profile, based on whether a user has confirmed the identifying and/or determining made by the machine learning model, etc.); and performing any other operations conducted in the system 100 or otherwise. In certain embodiments, multiple servers 160 may be utilized to process the functions of the system 100. In certain embodiments, the server 160 and other devices in the system 100, may utilize the database 155 for storing data about the devices in the system 100 or any other information that is associated with the system 100. In certain embodiments, multiple databases 155 may be utilized to store data in the system 100.

Although FIGS. 1-22 illustrate specific example configurations of the various components of the system 100, the system 100 may include any configuration of the components, which may include using a greater or lesser number of the components. For example, the system 100 is illustratively shown as including a first user device 102, a second user device 111, a communications network 135, a server 140, a server 145, a server 150, a server 160, and a database 155. However, the system 100 may include multiple first user devices 102, multiple second user devices 111, multiple communications networks 135, multiple servers 140, multiple servers 145, multiple servers 150, multiple servers 160, multiple databases 155, or any number of any of the other components inside or outside the system 100. Furthermore, in certain embodiments, substantial portions of the functionality and operations of the system 100 may be performed by other networks and systems that may be connected to system 100.

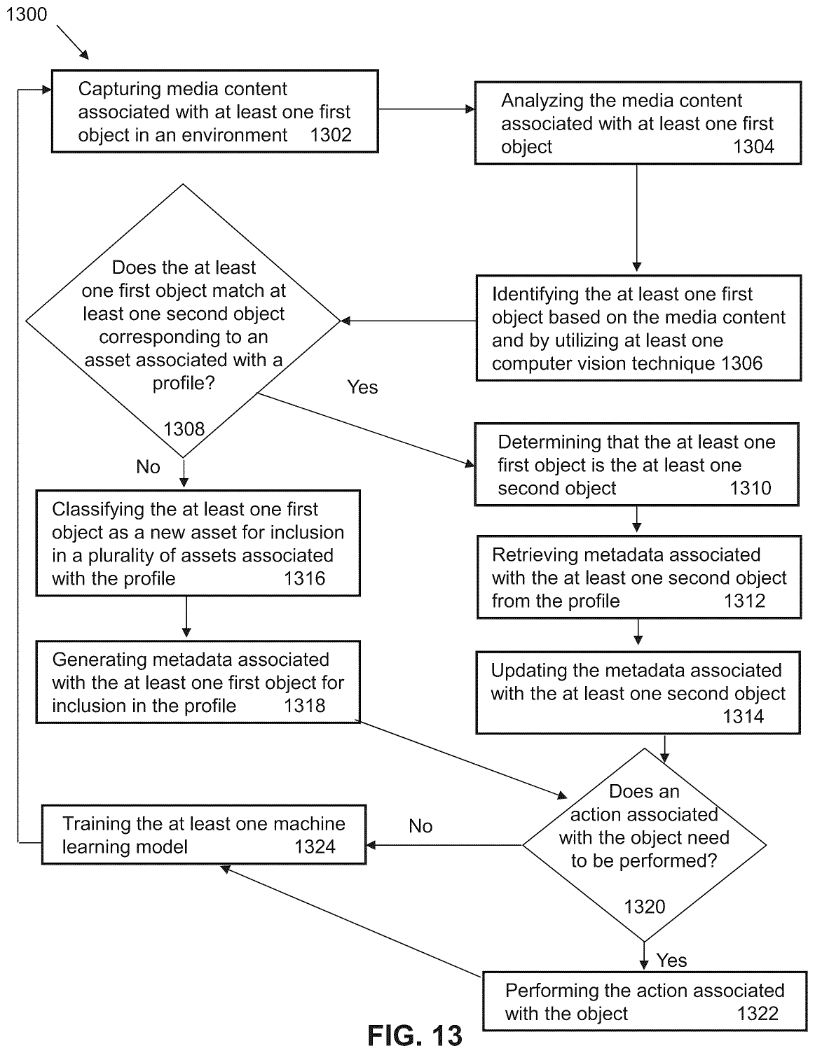

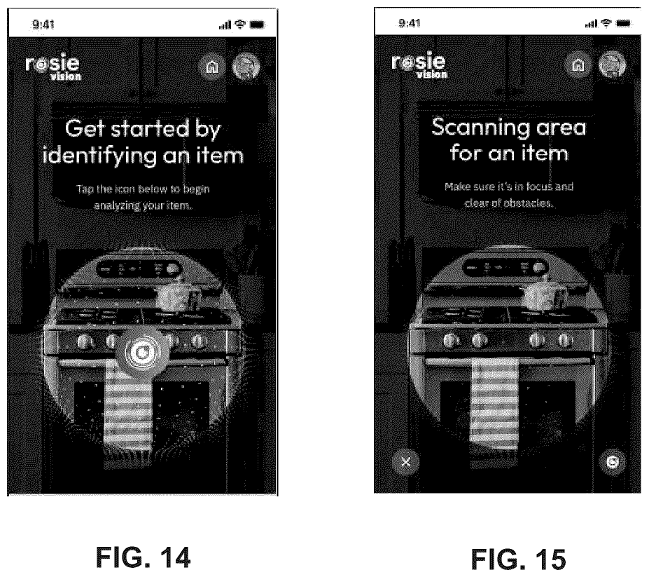

Notably, the system 100 may execute and/or conduct the functionality as described in the method(s) that follow. As shown in FIG. 13, an exemplary method 1300 for utilizing machine learning models and/or other technologies to process, organize, and manage tangible objects and associated metadata is schematically illustrated. In certain embodiments, the method of FIG. 13 can be implemented in the system of FIGS. 1-12, the system of FIG. 14, and/or any of the other systems, devices, and/or componentry illustrated in the Figures. In certain embodiments, the method of FIG. 13 may be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 13 may be performed at least in part by one or more processing devices (e.g., processor 102, processor 122, processor 141, processor 146, processor 151, and processor 161 of FIG. 1). Although shown in a particular sequence or order, unless otherwise specified, the order of the steps in the method 1300 may be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In certain embodiments, the method 1300 and/or functionality and features supporting the method 1300 may be conducted via an application of the system 100, machine learning and/or artificial intelligence models of the system 100, devices of the system 100 (e.g., first user device 102, etc.), processes of the system 100, any component of the system 100, or a combination thereof. Generally, the method 1300 may include steps for capturing media content associated with an object located in an environment, analyzing the media content associated with the object by utilizing a machine learning model(s) and/or other technologies, identifying the object based on analyzing the media content and/or by utilizing computer vision techniques utilized by the machine learning model(s), determining whether the identified object matches an object in a plurality of assets of a profile of a user, classifying the object as a new asset for inclusion in the assets associated with the profile if the object does not match an object in the plurality of assets, retrieving metadata associated with the object if the object matches the object in the assets of the profile, updating the metadata, determining whether an action needs to be performed with respect to the object, performing an action with respect to the object, and training the machine learning model based on the outputs of the process.

At step 1302, the method 1300 can include capturing media content associated with an object in an environment, such as a first object. For example, the media content can be captured by a camera of first user device 102 that can be utilized by a first user 101 (or second user 110). In certain embodiments, the media content can include video content, audio content, audiovisual content, virtual reality content, augmented reality content, text content, image content, perceivable content, sensory content, any type of content, or a combination thereof. In an exemplary scenario, the first user 101 can direct a lens of a camera of first user device 102 towards an object in the first user's 101 home and capture the media content of the object by utilizing controls of the first user device 102 and/or software controls accessible via a user interface of an application executing on the first user device 102. In certain embodiments, the method 1300, at step 1302, at another step of the method 1300, and/or after a first run of the method 1300, can include presenting a digital holographic label for an object. For example, the holographic label can be presented on a user interface of a device of a user that is viewing the object via the interface, such as when the camera of the device is activated and directed towards the object. The digital holographic label, in certain embodiments, can be presented via an application of the system 100 such that the digital holographic label is presented as being overlaid on the object via the graphical user interface, in proximity to the object, adjacent to the object, and/or at another location with respect to the object when viewed via the graphical user interface. In certain embodiments, the digital holographic label can be utilized to store information and/or metadata associated with the object that can be accessed by the user interacting with the digital holographic label (e.g., by tapping on it and/or by clicking on it) and/or by selecting an option within the application.

In certain embodiments, at least one sensor can be configured to scan the at least one first object or capture the media content associated with the at least one first object. In certain embodiments, the processor of the system 100 can be further configured to present a holographic label on the at least one first object, in proximity to the at least one first object, or a combination thereof. In certain embodiments, the processor can be configured to enable, if the at least one first object matches at least one second object in the system 100 (e.g., for which information is stored in the system 100), the metadata associated with the at least one second object to be presented via a graphical user interface of an application of the system 100 in response to an interaction with the holographic label.

In certain embodiments, the method 1300, at step 1302 or at another step of the method 1300, can include scanning a physical holographic label affixed to and/or in proximity to the first object. The holographic label can have information associated with the object and/or metadata associated with the object, which can be retrieved and displayed upon scanning. In certain embodiments, at step 1302 or at another step of the method 1300, infrared marking of objects (e.g., made by an infrared pen or other device) can also be scanned by the system 100. For example, each object can have its own unique infrared marking (e.g., different types of pixels and/or amount of pixels, type of marking, size of marking, and/or other characteristics of the marking) and a sensor or other component of a device of the system 100 can scan the infrared marking to retrieve information and/or metadata associated with the object. Various techniques, such as but not limited to, sematic segmentation can be utilized by the system 100 to differentiate infrared markings of one object from another, and to retrieve information and/or metadata stored in the system 100 about the object. In certain embodiments, capturing of the media content associated with the object can be performed and/or facilitated by utilizing the first user 101, the second user 110 and/or by utilizing the first user device 102, the second user device 111, the server 140, the server 145, the server 150, the server 160, the communications network 135, any component of the system 100, any combination thereof, or by utilizing any other appropriate program, network, system, or device. In certain embodiments, the capturing of the media content can be performed by utilizing any number and/or type of sensors capable of capturing the media content and/or sensor data in the environment. In certain embodiments, the capturing can also include capturing any type of sensor data associated with the object in the environment in addition to or instead of capturing the media content associated with the object.

At step 1304, the method 1300 can include analyzing the media content and/or sensor data associated with the object (e.g., first object) that has been captured. In certain embodiments, the system 100 can analyze the media content and/or sensor data, such as by utilizing software incorporating algorithms, including, but not limited to, algorithms to implement computer-vision functionality and/or techniques (e.g., edge detection, feature extraction, template matching, histogram-based methods, etc.). In certain embodiments, the media content and/or sensor data can be analyzed by utilizing a machine learning model(s) (and/or artificial intelligence model). In certain embodiments, the captured media content (and/or sensor data) can be loaded into the machine learning model(s) for analysis. In certain embodiments, the machine learning model(s) can be a file, program, module, and/or process that may be trained by the system 100 (or other system described herein) to recognize certain patterns, detect objects, identify objects, classify objects, generate metadata associated with the objects, and/or perform any of the functionality of the system 100. In certain embodiments, the machine learning model can be configured to utilize any number of computer vision techniques and/or algorithms to enable the machine learning model to detect objects, identify objects, classify objects, determine a condition of objects, perform actions with respect to objects, generate predictions for objects (e.g., predict how the condition of the object will change over time, predict when to replace a component of the object, predict a price for the object, predict any aspect of the object, or a combination thereof, etc.). In certain embodiments, the machine learning models can be configured to conduct image classification, object detection, semantic segmentation, instance segmentation, object tracking, feature detection and description, image registration, image enhancement and restoration, any other computer vision techniques and/or algorithms, or a combination thereof. In certain embodiments, the machine learning models can be configured to utilize and/or incorporate Support Vector Machines (SVM), random forests, k-nearest neighbors, recurrent neural networks, clustering algorithms, principal component analysis, t-SNE, ensemble techniques and methods, transfer learning, multi-modal learning, time series classification, statistical features, time-domain features, frequency-domain features, any other types of artificial intelligence and/or machine learning techniques, or a combination thereof. In certain embodiments, the machine learning model may be, may include, and/or may utilize a Deep Convolutional Neural Network, a one-dimensional convolutional neural network, a two-dimensional convolutional neural network, a Long Short-Term Memory network, autoencoders, generative adversarial networks, vision transformers, any type of machine learning system, any type of artificial intelligence system, or a combination thereof. In certain embodiments, the machine learning model(s) may incorporate the use of any type of artificial intelligence and/or machine learning algorithms to facilitate the operation of the machine learning model(s). Notably, the system 100 may utilize any number of machine learning models. In certain embodiments, the system 100 can train the machine learning model(s) to reason and learn from data and/or information fed into the system 100 so that the machine learning model(s) can enhance the capabilities of the machine learning model(s) over time.

In certain embodiments, the machine learning model(s) can be trained with data, such as, but not limited to, images, video content, audio content, text content, augmented reality content, virtual reality content, information relating to patterns, information relating to behaviors of objects, information relating to characteristics of objects, manufacturing specifications, owner specifications of objects, sensor data (e.g., motion data, orientation data, temperature data, pressure data, humidity data, light data, any type of sensor data, or a combination thereof, etc.), any type of data, or a combination thereof. In certain embodiments, the machine learning model(s) can be trained with metadata associated with objects, such as, but not limited to, sizes of objects, shapes of objects, dimensions of objects, life expectancies of objects, information identifying alternate objects that serve as substitutes for objects, repair information for objects, warranty information for objects, pricing information for objects, service information for objects (e.g., the type of service require to repair, maintain, or fix an object), component information for objects (e.g., information identifying components and characteristics of components of objects), recommendations for objects (e.g., recommendations to replace an existing object with a new version of the object or a substitute object providing the same or similar characteristics and/or functionality as an existing object of a user, etc.), any other information, or a combination thereof. In certain embodiments, the machine learning model(s) can be trained using unsupervised learning and/or supervised learning that can involve using training data that is labeled. For example, in supervised learning embodiments, data associated with a particular object can be labeled with an identification of the type of object, a characteristic of the object, a functionality of the object, a class of the object, a condition of the object (e.g., new, needs repair, damaged, old, can be fixed, needs replacement, etc.), any other label, or a combination thereof.

In certain embodiments, the data that is utilized to train the machine learning model(s) can be utilized by the machine learning model(s) to recognize a particular type of object, determining whether an object matches an object stored as an asset of a plurality of assets stored in a user's profile, generate metadata for an object (e.g., based on detection of the type of object, condition of the object, etc.), classify the object as being a new object that is not currently an asset of the user profile, recognize patterns associated with the object, perform comparisons between and/or among objects, provide recommendations for an object (e.g., the object needs to be fixed, the object can be sold at a certain price, the object needs to be serviced, the object needs to be replaced by a new object or a substitute object, etc.), determine whether an action needs to be performed with respect to the object, identify an owner of the object, identify a borrower of the object, track an object over a period of time, perform any other operations described in the present disclosure, or a combination thereof. For example, if the machine learning model is trained with thousands of images and/or textual words that are known to be associated with a particular type of object, the machine learning model may learn that information that is fed into the machine learning model at a future time are also associated with the object based on the future images and/or content having a correlation (e.g., a threshold correlation) and/or pattern in common with the characteristics with any number of the images and/or textual words that are used to train the machine learning model. As additional data and/or content is fed into the machine learning model(s) over time, the machine learning model(s)'s ability to recognize objects, recognize conditions of objects, provide recommendations with respect to objects, and/or perform any of the operative functionality of the system 100 will improve and will be more finely tuned over time. In certain embodiments, the machine learning models can be trained to predict when a particular object will need to be replaced, will need to be repaired, will need to be sold, will need to be maintained, will need to be services, and the like.

At step 1304, when analyzing media content and/or sensor data captured of an object in an environment or location, the system 100 can extract features from the media content to facilitate the analysis of the object. For example, if the media content is an image of the object, such as an image of a chair of a user, the system 100 can extract features from the image and apply classification rules on the extracted features to predict the labels for the features and ultimately the object itself. In certain embodiments, features that can be extracted from an image or media content can include, but are not limited to, color features, texture features, edge features, contour features, key points and descriptors, deep learning features, region-based features, image and/or media content statistics, temporal features (e.g., motion between frames, dynamic changes in content, etc.), contextual features (e.g., features relating to the object and its relationship with aspects of the environment, such as time, temperature, humidity, season, etc.), any other features, or a combination thereof. In certain embodiments, features that can be extracted from sensor data can include, but are not limited to, statistical features (e.g., mean, variance, standard deviation, skewness, kurtosis, etc.), peak features (e.g., peak frequency, number of peaks, peak-to-peak values, etc.), energy and amplitude (e.g., root mean square, mean absolute deviation, etc.), frequency domain features (e.g., Fourier transform features), temporal features and/or patterns, periodicity-based features, domain-specific features (e.g., how quickly temperature changes for the object or in environment), feature interactions, visual features, any other types of features, or a combination thereof. In certain embodiments, for machine learning models trained using supervised learning, the machine learning model can predict the label(s) for the image of the object based on the extracted features matching or having a threshold or correlation with labeled features utilized to train the machine learning model. For example, if the machine learning model was trained with labeled data indicating that certain features correspond to a desk and the extracted features from the input image taken at the first user's 101 office correlate and/or match with the features utilized to train the machine learning model, the machine learning model can determine that the object in the image is a desk. In certain embodiments, the analyzing the of the media content associated with the object can be performed and/or facilitated by utilizing the first user 101, the second user 110 and/or by utilizing the first user device 102, the second user device 111, the server 140, the server 145, the server 150, the server 160, the communications network 135, any component of the system 100, any combination thereof, or by utilizing any other appropriate program, network, system, or device.

In certain embodiments, in addition to utilize machine learning model(s) to conduct the analysis or as another option to conduct the analysis of the media content and/or sensor data, the system 100 utilize other computer vision and/or detection technologies to analyze the media content. In certain embodiments, the system 100 can utilize software programs and associated algorithms to conduct feature extraction and matching. For feature extraction and matching, the system 100 can extract distinctive features from the media content and/or sensor data, such as, but not limited to, corners or edges. The system 100 can then match the corners or edges across various media content stored in the system 100 to determine and/or identify a particular object. For example, if there are numerous images of a keyboard stored in the system 100, and the system 100 has captured media content of the first user's 101 office, the system 100 can extract features, such as corners or edges and compare the extracted corners and/or edges to corners and/or edges stored in the system 100. If the extracted corners and/or edges match the corners and/or edges of the images of the keyboard that are stored in the system 100, the system 100 can determine that the object in the media content is a keyboard of a certain type, such as in step 1306.

As another example of a computer vision technique that can be deployed by the system 100, the system 100 can utilize template matching or pattern matching. In certain embodiments, template matching can include comparing a portion of the media content (e.g., a template) and/or sensor data with various portions (e.g., sub-regions) of a larger image to find instances of the template. If the portion of the media content and/or sensor data matches one or more portions of the larger image, the object in the portion of the media content can be determined to be the same or similar object as found in the one or more portions of the larger image. Using the example above, a portion of the media content and/or sensor data can be compared to a larger version of the media content to determine whether a pattern in the portion matches patterns in other regions of the larger version of the media content. For example, if a pattern of pixels in the portion of the media content matches patterns of pixels in other portions of the larger version of the media content that are known to correspond with a keyboard, the system 100 can determine that the object in the portion of the media content is also a keyboard.

As a further example of a computer vision technique that can be deployed by the system 100, the system 100 can utilize edge detection. In certain embodiments, edge detection can include detecting edges or boundaries within the media content and/or sensor data to facilitate the identification of objects present in the media content. For example, the edges or boundaries can be utilized to identify or locate substantial changes in intensity or color within certain regions of the media content and/or sensor data, which can correspond to edges or transitions between objects within the media content. The system 100 can compare the edges, boundaries, and/or transitions within the media content and/or sensor data to edges, boundaries, and/or transitions in other media content that are known to correspond to a particular type of object and determine that the media content contains that type of object.

As yet another example of a computer vision technique that can be deployed by the system 100, the system 100 can utilize histogram-based computer vision techniques. In certain embodiments, histogram-based computer vision can include analyzing and utilizing the distribution of pixel intensities and/or colors in the media content and/or sensor data to facilitate identification of an object in the media content. For example, the system 100 can utilize histogram matching (e.g., where the intensity distribution of the media content is matched to a specified histogram), color histograms (e.g., where the color histograms represent the distribution of color values in the media content and/or sensor data and are compared to media content indexed based on color distributions that are associated with certain types of objects), grayscale histograms, histogram-based segmentation, histogram equalization, and other histogram-based techniques to analyze and identify objects in an environment. Notably, the system 100 can utilize any other computer vision techniques alone or in combination with any other computer vision techniques and/or machine learning model(s) to perform the analyses of step 1304, the identifications performed in step 1306, and/or any of the other functionality of the method 1300 and/or system 100.

At step 1306, the method 1300 can include identifying (or predicting) the object (e.g., first object) based on the media content and/or sensor data, and by utilizing one or more computer vision techniques and/or algorithms utilized by the machine learning model(s). For example, the machine learning model can deploy and utilize computer vision techniques, such as, but not limited to, image classification, object detection, semantic segmentation, instance segmentation, object tracking, feature detection and description, image registration, image enhancement and restoration, any other computer vision techniques and/or algorithms, or a combination thereof. In certain embodiments, for example, image classification can include having the machine learning model categorize the media content (e.g., an image) and/or sensor data into a particular class or category, such as by utilizing convolutional neural networks, vision transformers, and/or other techniques. In certain embodiments, object detection can include identifying and locating each object within the media content and/or sensor data, such as by utilizing single shot multibox detector (SSD), you only look once (YOLO), region-based convolutional neural networks (R-CNN), and/or other object detection techniques. In certain embodiments, semantic segmentation can include having the machine learning model assign a label to each pixel in an image and partitioning or segmenting the image into regions. In certain embodiments, instance segmentation can include assigning a class label to each pixel, while distinguishing between individual object instances. In certain embodiments, object tracking can include locating and tracking objects of interest across consecutive frames in the media content, such as by utilizing correlation filters, deep learning-based methods, Kalman filters, and/or other techniques. In certain embodiments, feature detection can include identifying points of interest in the media content, and feature description can include generator descriptors for the points of interest to facilitate matching across media content. For example, feature detection and description techniques can include orientated FAST and Rotated BRIEF, Speeded up Robust Features, Oriented FAST, Scale-Invariant Feature Transform, and/or other techniques. In certain embodiments, image registration can include aligning multiple media content taken of the object taken at different times, from different angles and/or orientations, and/or from different devices (e.g., sensors). In certain embodiments, image enhancement and restoration can include enhancing the quality of the media content, sharpening details, correcting distortions, and the like.

In certain embodiments, for example, the machine learning model can compare the extracted features from the input media content and/or sensor data and correlate and/or match them with the features and/or other data utilized to train the machine learning model to identify the object in the input media content and/or sensor data. In certain embodiments, the identifying of the object can be performed by utilizing any computer vision or other machine learning technique. In certain embodiments, the identifying of the object can be performed and/or facilitated by utilizing the first user 101, the second user 110 and/or by utilizing the first user device 102, the second user device 111, the server 140, the server 145, the server 150, the server 160, the communications network 135, any component of the system 100, any combination thereof, or by utilizing any other appropriate program, network, system, or device.

At step 1308, the method 1300 can include determining whether the object (e.g., first object) matches an object (e.g., a second object) corresponding to an asset associated with a profile. In certain embodiments, the profile can be a profile of the first user 101 and can include a list of assets of the first user 101 that the first user 101 wants to monitor and/or track over time. In certain embodiments, any number of objects can be included in the list of assets and the list of assets can include media content taken of each object, metadata describing each object in the list, information indicating a condition of each object, an identification of a type of the object, an identification of characteristics of each object, any other information, or a combination thereof. In certain embodiments, the determining as to whether the object matches an object corresponding to an asset associated with a profile can be performed and/or facilitated by utilizing the first user 101, the second user 110 and/or by utilizing the first user device 102, the second user device 111, the server 140, the server 145, the server 150, the server 160, the communications network 135, any component of the system 100, any combination thereof, or by utilizing any other appropriate program, network, system, or device.

At step 1308, if the object is determined to match an object corresponding to an asset associated with the profile, the method 1300 can proceed to step 1310. At step 1310, the method 1300 can include determining that the object (e.g., first object) in the media content is the object (e.g., second object) corresponding to the asset in the list. In certain embodiments, the determining that the object in the media content is the object corresponding to the asset in the list can be performed and/or facilitated by utilizing the first user 101, the second user 110 and/or by utilizing the first user device 102, the second user device 111, the server 140, the server 145, the server 150, the server 160, the communications network 135, any component of the system 100, any combination thereof, or by utilizing any other appropriate program, network, system, or device. At step 1312, the method 1300 can include retrieving metadata associated with the object corresponding to the asset in the list that matches the object from the media content. In certain embodiments, the metadata can include, but is not limited to, sizes of objects, shapes of objects, dimensions of objects, life expectancies of objects, information identifying alternate objects that serve as substitutes for objects, repair information for objects, warranty information for objects, pricing information for objects, service information for objects (e.g., the type of service require to repair, maintain, or fix an object), component information for objects (e.g., information identifying components and characteristics of components of objects), recommendations for objects (e.g., recommendations to replace an existing object with a new version of the object or a substitute object providing the same or similar characteristics and/or functionality as an existing object of a user, etc.), any other information, or a combination thereof. In certain embodiments, the retrieving of the metadata can be performed and/or facilitated by utilizing the first user 101, the second user 110 and/or by utilizing the first user device 102, the second user device 111, the server 140, the server 145, the server 150, the server 160, the communications network 135, any component of the system 100, any combination thereof, or by utilizing any other appropriate program, network, system, or device.

At step 1314, the method 1300 can include updating the metadata associated with the object corresponding to the asset associated with the profile. For example, the metadata can be updated based on the analysis of the media content taken of the object and/or the identification of the object conducted by the machine learning model(s). In certain embodiments, the updated metadata can include information on the condition of the object, condition of components of the object, behavior information for the object (e.g., what activities and/or actions have been performed on the object and/or by the object), the media content taken of the object, information describing the object, any other information, or a combination thereof. In certain embodiments, the metadata can be automatically generated upon identification of the object, determination that the object matched to an object corresponding to an asset in the list, or a combination thereof.

If, however, at step 1308, the object is determined to not match an object corresponding to an asset associated with the profile, the method 1300 can proceed to step 1316 from step 1308. At step 1316, the method 1300 can include classifying the object as a new asset for inclusion in the plurality of assets in the list associated with the profile of the user. For example, the object can be a new asset that the first user 101 wants to be tracked and monitored over a period of time and to be added as an additional asset of the first user 101. In certain embodiments, the classifying of the object can be performed and/or facilitated by utilizing the first user 101, the second user 110 and/or by utilizing the first user device 102, the second user device 111, the server 140, the server 145, the server 150, the server 160, the communications network 135, any component of the system 100, any combination thereof, or by utilizing any other appropriate program, network, system, or device. In certain embodiments, at step 1318, the method 1300 can include generating metadata associated with the object for inclusion in the list of assets in the profile. For example, the metadata can be generated by the machine learning model and/or the system 100 that describes the object. In certain embodiments, the metadata can be text content, video content, image content, virtual reality content, augmented reality content, any type of content, or a combination thereof. In certain embodiments, the metadata can indicate a condition of the object, characteristics of the object (e.g., dimensions, shape, components, age, last repair or maintenance date, functionality provided by the object, capabilities of the object, etc.), any type of metadata, or a combination thereof. In certain embodiments, the generating of the metadata can be performed and/or facilitated by utilizing the first user 101, the second user 110 and/or by utilizing the first user device 102, the second user device 111, the server 140, the server 145, the server 150, the server 160, the communications network 135, any component of the system 100, any combination thereof, or by utilizing any other appropriate program, network, system, or device.

Whether it be from step 1314 or step 1318, a next step of the method 1300 can be step 1320. At step 1320, the method 1300 can include determining whether an action needs to be performed with respect to the object. For example, based on analyzing the media content captured at step 1302, the machine learning model(s) and/or the system 100 can determine whether an action needs to be performed. In certain embodiments, the action can be any type of action including, but not limited to, performing a repair on the object, scheduling and/or performing maintenance on the object, generating a recommendation to replace the object with a same type of object or a substitute object, manipulating the object, selling the object, providing additional information about the object (e.g., requesting the first user 101 to manually enter additional information about the object based on the first user's 101 perception and/or interaction with the object), performing any other action with respect to the object, or a combination thereof. As an illustrative example, if the media content captured at 1302 indicates that the object has experienced wear and tear since prior media content was obtained from the object and/or since a last update to the metadata in the profile for object, the machine learning model(s) can determine that a repair action needs to be performed on the object, that maintenance action needs to be performed on the object, that a replacement of a component of the object needs to be performed, or any other action needs to be performed . . . . In certain embodiments, the determining of whether an action needs to be performed can be performed and/or facilitated by utilizing the first user 101, the second user 110 and/or by utilizing the first user device 102, the second user device 111, the server 140, the server 145, the server 150, the server 160, the communications network 135, any component of the system 100, any combination thereof, or by utilizing any other appropriate program, network, system, or device.

If, at step 1320, it is determined that an action needs to be performed with respect to the object, the method 1300 can proceed to step 1322. At step 1322, the method 1300 can include performing the action associated with the object. In certain embodiments, for example, performing the action could include transmitting a notification to the first user or an authorized individual to indicate that the action needs to be performed by them. In certain embodiments, however, the system 100 can transmit a signal to a robot or other device, such as robot 170, to perform the action with respect to the object. In certain embodiments, performing the action can be performed and/or facilitated by utilizing the first user 101, the second user 110 and/or by utilizing the first user device 102, the second user device 111, the server 140, the server 145, the server 150, the server 160, the communications network 135, any component of the system 100, any combination thereof, or by utilizing any other appropriate program, network, system, or device.

At step 1324, the method 1300 can include training the machine learning model(s). For example, in certain embodiments, the machine learning model(s) can be trained based on the media content, the analysis of the media content, identifications of the objects, the metadata, new objects, metadata associated with new objects, actions that are performed with respect to the objects, any other type of training data, or a combination thereof. In certain embodiments, the system 100 can determine whether the determinations and/or predictions made by the machine learning model(s) (e.g., identifications of objects, analyses of objects, classifications of objects, sensor data, determinations as to whether an object depicted in media content matches an object in a list of assets in a profile of a user, etc.) are accurate, such as based in comparison to determinations made by a human, the robot 170, and/or another device of the system 100. If the determinations made by the machine learning model(s) are accurate, then that can validate the accuracy of the machine learning model(s) and the machine learning model(s) can be rewarded, such as if reinforcement learning is utilized. In certain embodiments, for example, if the determinations made by the machine learning model(s) are not accurate or are invalidated by the human, the robot 170, and/or another device of the system 100, feedback associated with the inaccuracy can be utilized to train the machine learning model(s) so that future determinations and/or predictions increase in accuracy and the process can be repeated over time to continuously increase the performance of the machine learning model(s).

In certain embodiments, the training can performed to enhance predictions, deductions, reasoning, intelligence, correlations, outputs, analyses, and/or other capabilities of the machine learning model(s). In certain embodiments, the machine learning models(s) can be updated with new and/or updated computer vision techniques, machine learning algorithms, or a combination thereof. In certain embodiments, the training may be performed and/or facilitated by utilizing the first user 101, the second user 110 and/or by utilizing the first user device 102, the second user device 111, the server 140, the server 145, the server 150, the server 160, the communications network 135, any component of the system, any combination thereof, or by utilizing any other appropriate program, network, system, or device. At step 1320, if the system 100 determines that an action does not need to be performed with respect to the object, the method 1300 can proceed directly to the training step 1324 from step 1320. The method 1300 can then proceed to step 1302 can capture media content at a different time period of the object, a different object, or a combination thereof, and the process can be repeated continuously, on a periodic basis, or on a random basis. Notably, the method 1300 may further incorporate any of the features and functionality described for the system 100, any other method disclosed herein, or as otherwise described herein. Moreover, any of the functionality of the method 1300 can be performed using machine learning models, software performing computer vision techniques, devices configured to perform the functionality of the method 1300, or a combination thereof.

The systems and methods disclosed herein can include additional functionality and features. For example, the system 100 can recall object information stored in the system 100 by using a mobile device and/or camera lens to hover over an object and/or take media content of the object to match it to a user's profile. In certain embodiments, the information (e.g., metadata) can be recalled simply by using the camera lens of the user device to populate the information that the user is searching for and without having to search through the user's profile. In certain embodiments, the profile including the list of assets can be made accessible and/or identifiable via a website of the system, an application of the system 100, and/or by pointing to a mobile device and/or camera lens on an object to enable the system 100 to identify and provide asset details. The system 100 can track any type of data point associated with an object, such as, but not limited to, warranty information, date of purchase information, service information, serial numbers and product model information, record keeping information (e.g., has service been performed on the object), how-to-media content (e.g., how to use the object, repair it, service it, and/or replace it), training content, information identifying components to replace (e.g., filters of an A/C unit), service repair companies in proximity to a location containing the object, service history, data information relating to characteristics of the objects, (e.g., size, dimensions, etc.), possible replacement objects of the object has failed or whether it is time to buy a new object, an identification of a similar but not the same object that has comparable functionality or better functionality, any other information, or a combination thereof. In certain embodiments, the system 100 can include an online marketplace to sell the objects on the internet and/or online systems, the ability to share object identities with other users and/or devices, sharing inventories of objects with insurance companies (e.g., so that insurance companies can also determine conditions of objects that are insured), valuing objects, and the like.

In certain embodiments, the system can include enabling communication with artificial intelligence engines of the system 100. For example, the user can ask the artificial intelligence engines what is wrong with an object, what does the object needs, is the object operating correctly and/or efficiently, and the like. In certain embodiments, the system 100 can track power information for an object to determine whether the object is operating efficiently. In certain embodiments, the system 100 can understand electronics or whether anything electric is being used when it should not be (e.g., fans have been left on overnight or lights have been left on for no apparent reason). In certain embodiments, robots (e.g., robot 170) can be utilized to automate all electronically connected devices and can be provided with instructions dictating how to operate at a user's location and when.

The systems and methods disclosed herein can include further features and functionality. In certain embodiments, the application supporting the functionality of the system 100 can provide an option to a user (e.g., first user 101) to upload media content, such as video into the application. For example, the first user 101 can utilize the first user device 102 to capture media content using a camera of the first user device 102 without necessarily having to use the application to activate the capturing of the media content. The first user 101 can instead directly activate the camera or other sensor of the first user device 102 and capture media content of the object (e.g., object 107) and upload the captured media content into the application to be processed and/or analyzed by the application. In certain embodiments, the application can include functionality to enable tagging the media content captured of the object 107 using a link associated with the first user 101, another user (e.g., second user 110), or a combination thereof. The tag can be accessed or interacted with by anyone tagged onto the media content via the application. In certain embodiments, the application can enable the first user 101 to send the captured media content to another user's device (e.g., second user device 111) via a text message, a digital link, a notification, or a combination thereof, such as via the application or via the messaging capabilities of the first user device 102. In certain embodiments, the recipient of the media content can review the media content and the feedback associated with the media content can be sent by the recipient back to the first user device 102 via a communication. The feedback can be stored in the application or otherwise on the first user device 102.

As an example, a user can upload a video depicting and/or describing how to operate a sprinkler system at a premises and how to program the sprinkler system. The user can send the video or a link to the video via the application and/or via other means, such as via text message, which can also enable the other user to comment on the video and/or make suggestions. As another example, a user can create media content (e.g., a video) describing and/or visually depicting how to maintain a fish tank and how to feed the fish in the tank on a daily basis. As yet a further example, a user can generate a video on how to operate pool equipment and/or pool accessories. Since many pools in today's society incorporate increasing amounts of automation, such a video can be useful for others in understanding how to operate pool-related equipment. Based on feedback provided by users, the user can modify and/or update the media content accordingly. In certain embodiments, based on the feedback provided by users, one or more artificial intelligence models and/or an agent (described further herein) can automatically modify the media content in accordance with the feedback.

In certain embodiments, the media content, metadata associated with the object, or a combination thereof, can be converted into a token or a token can be generated by utilizing any of the foregoing. In certain embodiments, the media content and/or metadata can be utilized to create titles for each object and certificates of ownership for the object. The certificate of ownership can be evidence that the particular object is an asset of a particular user, for example, and can be utilized to validate the authenticity of the object and/or that the first user 101 owns the object, such as during a sale or transfer of the object to another. In certain embodiments, the systems and methods can utilize semantic segmentation, such as in conjunction with an infrared pen, to mark each object in a unique manner. The marking can be performed by utilizing the infrared pen such that it is not visible to a human eye, but it is visible via the camera or other sensor of the first user device 102 (or other device of the system 100). In certain embodiments, the system 100 can, such as by utilizing the marking, can create a specific object identification technique that only the system 100 can manage, read (or scan), and/or inventory.

In certain embodiments, system 100 can incorporate the use of a pre-trained transformer agent. For example, the agent can comprise software that includes functionality and features supported by one or more artificial intelligence models. The agent can have an avatar or other graphical representation, which the user utilizing the application can perceive and/or interact with. For example, the agent can be visually represented as a person, a robot, an animal, any type of being, an interactable object, or a combination thereof. The agent can be rendered via user interface of an application executing on a device (e.g., first user device 102) that the user is utilizing while interacting with the application. The agent can be configured to interact with the user, such as by asking questions, responding to questions, capturing speech and/or data supplied by a user, identifying objects in a particular location, providing information associated with the objects, modifying captured speech and/or data to create media content or other type of content, any other actions, or a combination thereof. In certain embodiments, the agent can be periodically or continuously trained so that its interactions with the user become more efficient over time and the agent adapts to the user's personality, preferences, and/or characteristics. For example, artificial intelligence models supporting the functionality of the agent can be fed with data associated with the user so that the agent can be optimized in terms of its behavior and other characteristics for the user. As time progresses, the agent can be trained further as the user's behavior and/or interactions with the agent change over time.

In certain embodiments, the agent can be configured to assist the user in capturing media content and/or scanning objects in an environment, such as the user's home or office. The agent can also prompt the user to use the first user device 102 in a specific manner to capture the media content and/or to scan the objects. In certain embodiments, the agent can facilitate the user in taking an inventory of the user's inventory of assets, to generate metadata associated with the assets, to retrieve metadata associated with the assets, to compare the media content and/or scanned data to an object and/or media content and/or data in a profile of the user, to perform any of the operative functionality described in the present disclosure, or a combination thereof. In an exemplary use-case scenario, rental property owners can have a live chat for each property on their rental portal so that users can ask questions without having to bother with the rental agency. For example, a user can ask whether a particular property has a coffee machine, or whether the property has full kitchen utensils, or what the pool hours are, what type of parking is available (e.g., can a camper park at the property), what days are the trash days, any other characteristics associated with the property, or a combination thereof. Such information can be provided by the agent based on the information the agent is regularly obtaining from the user, the objects, or a combination thereof.

In certain embodiments, the systems and methods can be configured to facilitate reverse searching, such as through the use of metadata associated with an object (e.g., an object that is an asset in a list of assets of the user). For example, a user can input metadata (e.g., information describing and/or otherwise associated with an object) into the application, and the application can locate an object from the list of assets based on the input metadata matching metadata previously obtained for the object and/or having a threshold level of similarity to the metadata previously obtained for the object. As an example use-case scenario, if a user may have forgotten which objects (e.g., assets) the user bought during a particular month, the user can input speech into the application inquiring “What did I purchase in January 2018?” This input speech can serve as metadata by which the application can conduct a reverse search. For example, the application can determine that a car was tagged with January 2018 metadata, and that the input metadata matches the January 2018 metadata tagged with the car asset. Based on the foregoing, the application can return a response to the user that the car was purchased in January 2018 in response to the user's inquiry. As another example, the user can ask “how many of my air conditioning units use a 21×12×1 filter?” Based on the previous additions of the user's air conditioning units as assets into the system 100, the system 100 can use the metadata from the inquiry to match it with each air conditioning unit on the property having a 21×12×1 filter size or is compatible with a 21×12×1 filter size. As yet another example, the user can ask how many appliances in a particular environment use a particular type of filter. Based on the inquiry into the system 100, the system 100 can analyze the metadata and/or objects saved in the system 100 and determine that a certain set of appliances all use a particular type of filter or are capable of using the filter. The system 100 can then provide the option for the user to order filters for each appliance and can even adjust the dimensions of the type of filter to suit each particular appliance when presenting the option for each appliance.

In certain embodiments, the system 100 can incorporate billing and/or ordering functionality. For example, in a use-case scenario where a user is using the system 100 to track all maintenance-related expenses associated with the user's properties, the system 100 can enable the user to upload all invoices for each type of maintenance-related expense for each property. As an example, the system 100 can enable the user to upload all pool service, landscaping, housekeeping, air conditioning, plumbing, electrician, and/or other maintenance invoices into the application for each property. The system 100 can associated the invoices with the corresponding property so that the user can regularly track all associated invoices for each property location easily.

In certain embodiments, the system 100 can provide wayfinding and/or navigation capability. For example, when capturing the media content and/or sensor data for an object and/or environment, location data can be included with the media content and/or sensor data. The location data can be included as metadata for each object that is scanned by the system 100. The location data for the object can be combined and/or integrated into location data and/or mapping data for the environment in which the object resides, to create a navigation and/or wayfinding tool within the application of the system 100. The wayfinding tool can enable the user, such as when accessing the application, to visualize a route from the user's current location to the object so that the user can easily locate the object whenever the user desires. In certain embodiments, if the object is moved or adjusted, new media content and/or sensor data can be uploaded into the application and/or system 100 to update the routing provided to the user. In certain embodiments, the routing can be provided via a graphical user interface of a device of the user, speech directions via a speaker of the device of the user, sounds that change in frequency or intensity based on proximity to the object, any other means, or a combination thereof.

In certain embodiments, the system 100 can facilitate the management of multiple trades for properties. As an example, there can be a 50,000 sq. ft. property in a location that is managed by a property manager works directly with the property owner. The property manager can be tasked with the managing multiple trades for the property and upgrading what the property manager is responsible for the property. For example, the trades can be landscaping, air conditioning services, janitorial services, plumbing services, cleaning services, construction services, security services, and the like. Each service provider for each trade and/or the property manager can be provided with access to the application and/or system 100, and can enter in or scan information for each trade into the application and/or system 100 including, but not limited to, the types of materials being used, the progress of a particular job associated with the trade, the status of permits associated with the job, the status of workers working on the trade, any other information, or a combination thereof. With information associated with each trade input into the application, the property owner can readily view the statuses for each trade via the application and/or system 100. The system 100 can also enable the property owner, property manager, and each service provider to communicate with each other, to resolve issues, provide status updates, and provide suggestions on what to handle as the property is being managed and attended to. In certain embodiments, the property manager and/or owner can generate digital lists in the system 100 for each trade to take care of while the service provider is at the property site. There can be daily tasks and/or check lists provided that can be required to be completed.

In certain embodiments, the system 100 can enable a user to create different profiles for each property and/or asset of the user. For example, there can be separate profiles for the user's home, condominium, boats, cards, and/or other property. Each profile can have its corresponding service providers and/or managers, and information associated with each can be regularly updated and viewed by the user. For example, if a boat is being serviced by a service provider, the user owning the boat can track the progress of the service provider in providing the service. Additionally, the service provider and/or user can communicate with each other and obtain real-time updates associated with the service as well. The user can also provide feedback and/or rate the service provider. In certain embodiments, the system 100 can also enable a user to create profiles for the user's pets or even family. The system 100, for example, can keep track of shots, veterinary visits, food (e.g., can tie into applications of food vendors to order food or communicate regarding food for the pet), incidents, and/or other aspects associated with the user's pets. Similarly, the system 100 can track doctors' visits, food, progress at school, progress in completing tasks, and/or other aspects associated with the user's family.

In certain embodiments, the system 100 can incorporate the use of hologram and/or other types of labels that can be utilized with the objects and/or anything that the user wants to track and/or inventory. In certain embodiments, the holographic and/or other types of labels can be digital, physical, or a combination thereof. For example, in the case of a physical holographic label, a physical holographic label can be affixed to an object and can include metadata associated with the object, such as metadata obtained from captured media content and/or sensor data, metadata generated by the system 100 for the object, and/or any other metadata. Such information and/or metadata can be retrieved by scanning the physical holographic label. In the case of a digital holographic label, the digital holographic label can be presented via a graphical user interface of an application as being overlaid, in proximity to, adjacent to, or otherwise associated with an object in view of a user device (e.g., in view of a camera of the user device) or other device. When a user clicks on the digital holographic label or otherwise interacts with the digital holographic label, the information and/or metadata associated with the object can be retrieved and presented to the user via the application. In certain embodiments, the holographic label can include 3D images or patterns that can change appearance when viewed from varying angles, light reflection effects, branding information for the object, authentication information to authenticate the object, identification information to identify the object, metadata, or a combination thereof. In certain embodiments, the holographic label can include an image, code, and/or other information that can be scanned and saved into the application, and the image, code and/or other information can, in certain embodiments, be tied to the user's profile and can be utilized by the system 100 to identify the object as being in the user's asset list. The holographic labels can enable the capability of being able to identify that a particular object has been digitized. In certain embodiments, for example, the holographic labels (e.g., digital holographic labels and/or physical holographic labels) can be utilized to enable the capability of being able to identify that a particular object has been digitized by the system 100, has been digitized within a profile of the user in the application of the system 100 as an asset of the user, or a combination thereof. In certain embodiments, the object can be digitized within a private profile (e.g., a profile not available to users not associated with the profile), digitized within a publicly open profile (e.g., a profile with permissions set that allows other users to access, interact with, and/or view objects associated with the profile), digitized within a public portion of the system 100 (e.g., a website or application hosted by the system 100 that is accessible by various users), and/or elsewhere within the system 100. By using the holographic labels, the user can simply scan the label using the user's device and quickly retrieve all information associated with the object. This can remove any dependency on using bounding boxes over the object and enables a user to quickly see if the object has already been catalogued.

In certain embodiments, in addition to or instead of using digital and/or physical holographic labels, the system 100 can utilize infrared markings, which upon detection by the system 100, can be utilized to provide information and/or metadata associated with objects. For example, an object can be marked by an infrared pen or other marking device and the marking can have unique characteristics that can be utilized to differentiate each marking on an object from another marking on another object. For example, the marking can vary based on number of pixels, the size of the marking, the type of the marking, and/or by varying other characteristics of the marking. The system 100 can associate information and/or metadata for an object with the marking for the object so that when the infrared marking is scanned, the information and/or metadata can be retrieved by the system 100 and presented, such as via a graphical user interface rendered on a device of a user seeking to obtain information about the object. Various techniques, such as, but not limited to, semantic segmentation can be utilized by the system 100 to differentiate between scanned markings.

In certain embodiments, the system 100 can be utilized to scan objects, assets, and/or content of a user, an entity, or a combination thereof. In an exemplary use-case scenario, if an art museum has made available media content (e.g., photos and/or video content of the artwork at the museum) publicly available for accessing, such as by the system 100, the system 100 can access and/or copy such content, and then analyze the content to determine information associated with the content. As an example, media content can be analyzed by the system to determine artist information, the type of artwork, the age of the artwork, the style of the artwork (e.g., watercolor, oil painting, etc.), the value of the artwork, the owners of the artwork, any other information, or a combination thereof. Once the system 100 has determined information associated with the artwork, holographic labels can be generated and can be configured to include some or all of the determined information for each artwork in the museum. The holographic labels, for example, can be affixed or secured to containers containing the artwork, museum glass, conservation glass, walls, glazing, frames, and/or other areas. Once the holographic labels are secured, a user utilizing the system 100 that is visiting the museum can scan the holographic labels to learn about the artwork associated with the holographic label by retrieving the information and/or metadata included with the holographic label. In certain embodiments, for example, once a holographic label is scanned, the information and/or metadata associated with the artwork can be rendered for display by the system 100 on the first user device 102 for viewing and/or interacting. As another example, in the case of a digital holographic labels, media content of an artwork (or other object) that is analyzed by the system to determine information and/or metadata associated with the artwork can be associated with the digital holographic label and stored in conjunction with the digital holographic label. The holographic label can be presented in the graphical user interface as being overlaid (or superimposed) on top of the artwork, adjacent to the artwork, in proximity to the artwork, or a combination thereof. When a user interacts with the digital holographic label for a particular artwork (or other object) or selects an option associated with the digital holographic label, the information and/or metadata associated with the artwork can be presented to the user, such as via the application.

As another exemplary use-case scenario, the owner of a real estate property can make the information and metadata associated with the home and all objects in the home and/or on the property available on the system 100, such as via the owner's profile with the system 100, generally on the system 100, or a combination thereof. A renter that may want to rent the home on the property can download an application providing operative functionality of the system 100 onto the renter's user device (e.g., second user device 111) and then view and/or interact with all of the objects (or assets) of the owner's real estate property. In certain embodiments, the owner can also utilized holographic labels on some or all of the objects on the property as well, which the user can scan when viewing the property, for example.

In certain embodiments, the system 100 can also enable tracking of an object. For example, since media content and/or sensor data is being captured of the object in a particular environment, the system 100 can enable, such as through the use of artificial intelligence and/or machine learning models, to identify the location of objects in an environment, along with prior locations and current locations of the object. For example, a user can be provided with the capability to visualize all previous locations of the object so that the user can obtain assistance in locating the object if desired.

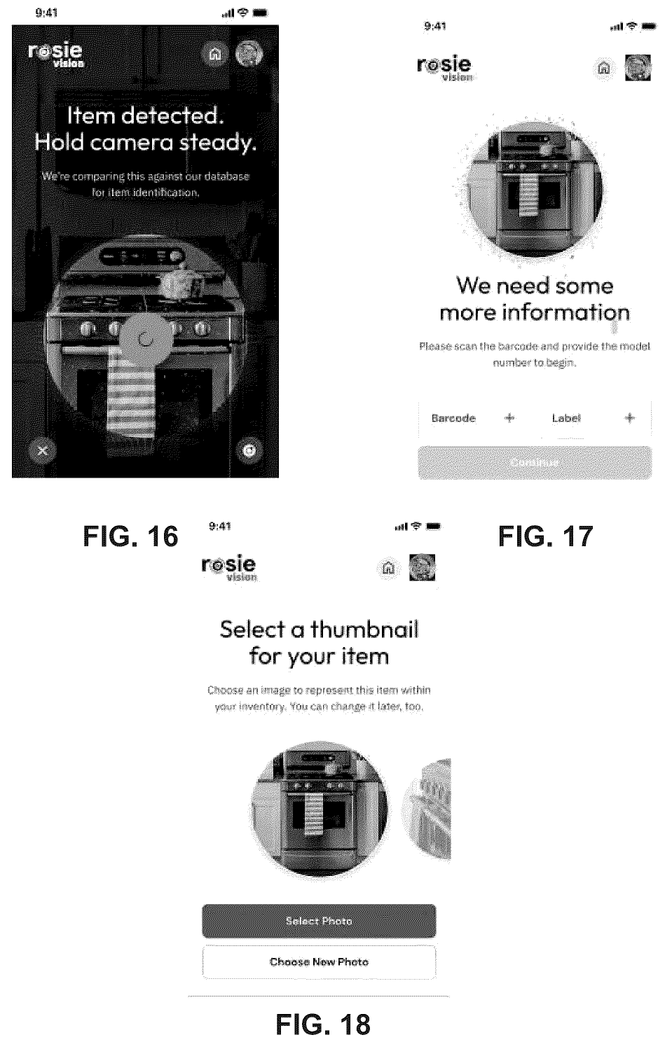

In certain embodiments, various types of graphical user interfaces can be utilized with the application supporting the functionality of the system 100. For example, referring now also to FIGS. 14, 15, 16, 17, 18, 19, 20, 21, 22, and 23, exemplary graphical user interfaces depicting various aspects of the application and/or system 100 are illustrated. FIG. 14, for example, illustrates an exemplary graphical user interface that enables a user to initiate identification of items. The application can activate the camera and/or sensor functionality of the user's device and the user can begin searching for objects in the environment to scan. FIG. 15 illustrates an exemplary graphical user interface that enables the scanning of an object in the environment. For example, in FIG. 15, the user can scan the oven and/or pot within the viewing range of the camera and/or sensing range of any sensors of the user's device. The user can capture media content and/or sensor data using the application. FIG. 16 illustrates an exemplary graphical user interface that shows detection of an object in the environment. For example, when the user is scanning the object in the environment, if the system 100 and/or application has scanned the object previously, catalogued the object in an inventory list, or a combination thereof, the system 100 can detect the object and provide metadata and/or other information associated with the object to the user. In certain embodiments, when the user is scanning the object in the environment, if the system 100 and/or application has scanned the object previously, the system 100 can detect the object in the system 100 and can provide and/or render metadata and/or other information associated with the object that is stored in the system 100 for viewing on the user's device (e.g., via interface 105), another device (e.g., an interface of robot 170), or a combination thereof. For example, using an example above, if the object is an oven and the oven was previously scanned, the system 100 can retrieve previously stored metadata and/or other information associated with the object and render the information and/or metadata for display on an interface of the user's device. In certain embodiments, the metadata and/or other information associated with an object can be displayed on or with a holographic image or label on and/or superimposed on the object, such as via the application supporting the operative functionality of the system 100.

In certain embodiments, if the system 100 cannot identify the scanned object, the system 100 can prompt the user for additional information and/or to perform an additional action with respect to the object. Referring now also to FIG. 17, an exemplary graphical user interface prompting the user to scan a barcode (or other machine-readable representation) of the object, scan a label of the object, and/or manually input information associated with the object is shown. The information input at the prompting of the system 100 can be utilized by the system 100 to identify the object. For example, based on scanning the barcode and/or label, the system 100 can retrieve information associated with the object from data sources and/or the system 100 itself that identifies the object. Referring now also to FIG. 18, an exemplary graphical user interface is shown that enables a user to select media content (e.g., a photo) to represent the object in the user's inventory asset list.

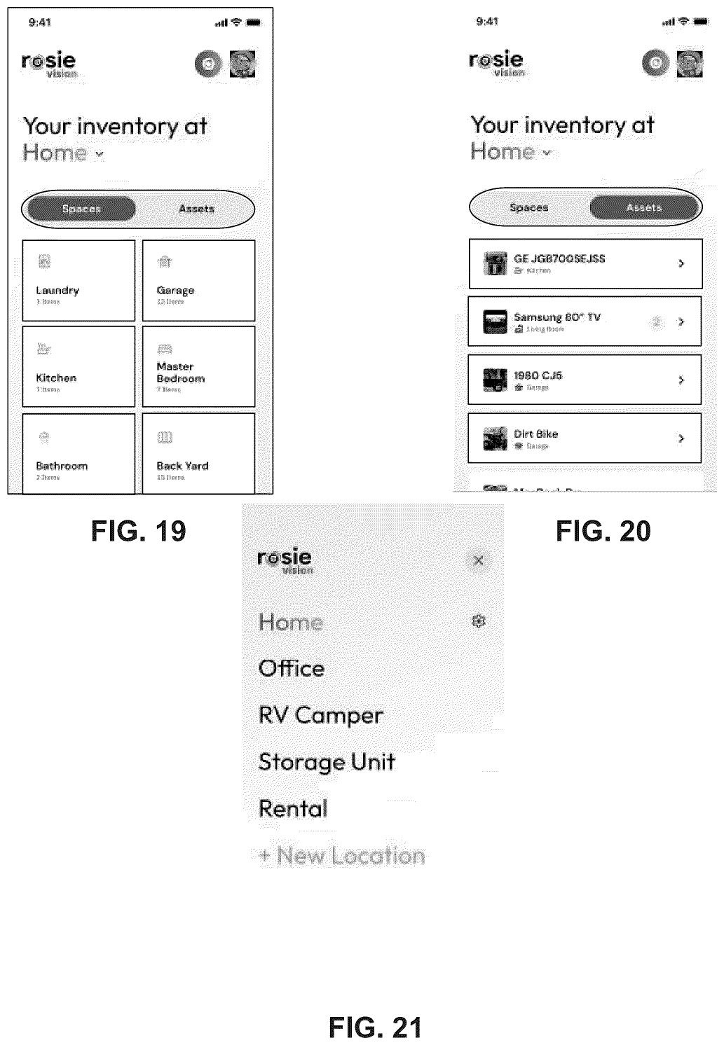

Referring now also to FIG. 19, an exemplary graphical user interface is shown that illustrates a list of spaces of a particular location associated with the user that the user can select to view the inventory asset list associated with each space. For example, in FIG. 19, exemplary spaces include the laundry area, the garage, the kitchen, the master bedroom, the bathroom, and the backyard of the user's home location. Each space can have objects associated with it and which can be viewed by the user. Referring now also to FIG. 20, an exemplary graphical user interface illustrating an inventory asset list for a specific space of the user is shown. For example, in FIG. 20, various appliances and vehicles of the user are shown. The user can select any asset from the inventory asset list to obtain, view, and/or interact with additional information and/or metadata associated with the asset (e.g., object). Referring now also to FIG. 21, an exemplary graphical user interface showing exemplary locations that can each have a profile associated with it. Such profiles, for example, can include, a home profile, an office profile, a RV camper profile, a storage unit profile, a rental profile, and/or any other location profile. The user can be enabled to add additional locations and/or remove locations at any time via the functionality provided by the application and/or system 100.

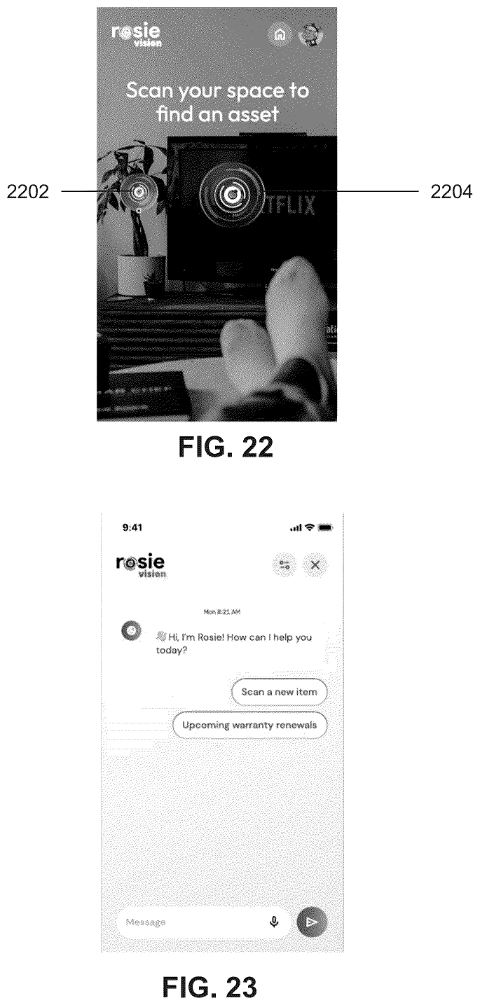

Referring now also to FIG. 22, an exemplary graphical user interface is shown that illustrates the use of holographic labels with various objects in an environment. For example, a first holographic label 2202 is used with a plant in the environment and a second holographic label 2204 is used on a television also located in the environment. In certain embodiments, the holographic labels 2202, 2204 can be positioned on an exterior surface of corresponding objects, in proximity to corresponding objects, on a box or cover of a corresponding object, anywhere with respect to an object, or a combination thereof. In certain embodiments, information and/or metadata associated with the object can be retrieved by scanning the corresponding holographic label, which can store the information and metadata associated with the object based on the specific characteristics, features, patterns, geometry, colors, and/or other aspects of the holographic label. When scanned, the device scanning the holographic label can retrieve the information and/or metadata from the characteristics of the holographic label. All of the information and/or metadata can be stored in the system 100 and/or rendered for display on an interface of a device of the system 100. In certain embodiments, a holographic label can be a digital label that can be configured to appear on a user interface of a device of the system 100 when a camera lens of the device is focused on a particular object corresponding to the holographic label.

Referring now also to FIG. 23, an exemplary graphical user interface is shown which illustrates chat functionality provided by the system 100. In certain embodiments, the chat functionality can involve the system 100 interacting with a user of the application providing the operative functionality of the system 100. In certain embodiments, the chat functionality can include asking questions to a user of the application, which the user can respond to. In certain embodiments, the chat functionality can provide options to the user to scan an object in an environment, perform various actions (e.g., renewing a warranty, update metadata for an object, etc.), and/or assist the user.

The systems and methods disclosed herein may include still further functionality and features. For example, the operative functions of the system 100 and method may be configured to execute on a special-purpose processor specifically configured to carry out the operations provided by the system 100 and method. Notably, the operative features and functionality provided by the system 100 and method may increase the efficiency of computing devices that are being utilized to facilitate the functionality provided by the system 100 and the various methods discloses herein. For example, by training the system 100 over time based on data and/or other information provided and/or generated in the system 100, a reduced amount of computer operations may need to be performed by the devices in the system 100 using the processors and memories of the system 100 than compared to traditional methodologies. In such a context, less processing power needs to be utilized because the processors and memories do not need to be dedicated for processing. As a result, there are substantial savings in the usage of computer resources by utilizing the software, techniques, and algorithms provided in the present disclosure. In certain embodiments, various operative functionality of the system 100 may be configured to execute on one or more graphics processors and/or application specific integrated processors.

Notably, in certain embodiments, various functions and features of the system 100 and methods may operate without any human intervention and may be conducted entirely by computing devices, robotic devices, other devices, or a combination thereof. In certain embodiments, for example, numerous computing devices may interact with devices of the system 100 to provide the functionality supported by the system 100. Additionally, in certain embodiments, the computing devices of the system 100 may operate continuously and without human intervention to reduce the possibility of errors being introduced into the system 100. In certain embodiments, the system 100 and methods may also provide effective computing resource management by utilizing the features and functions described in the present disclosure. For example, in certain embodiments, devices in the system 100 may transmit signals indicating that only a specific quantity of computer processor resources (e.g. processor clock cycles, processor speed, etc.) may be devoted to training the artificial intelligence model(s), capture media content associated with objects in an environment, analyzing the media content associated with the objects, identifying the objects, determining whether the objects match objects in a profile of a user, retrieving metadata for an object in a profile of a user, updating the metadata associated with the object, classifying the objects, determining whether an action needs to be performed with respect to the object, training machine learning models to perform detections and/or identifications of objects, training machine learning models to generate metadata associated with an object, training machine learning models to determine a condition associated with an object, training machine learning models to determine a type of action to perform with respect to the object, displaying information about the object on a user interface of a device of a user, and/or performing any other operation conducted by the system 100, or any combination thereof. For example, the signal may indicate a number of processor cycles of a processor may be utilized to update and/or train an artificial intelligence model, and/or specify a selected amount of processing power that may be dedicated to generating or any of the operations performed by the system 100. In certain embodiments, a signal indicating the specific amount of computer processor resources or computer memory resources to be utilized for performing an operation of the system 100 may be transmitted from the first and/or second user devices 102, 111 to the various components of the system 100.

The systems, methods, processes, devices, components, functionality, and features described in the present disclosure can be modified, adapted, and/or otherwise configured to be utilized with and support existing technologies and systems, future technologies and systems, or a combination thereof. In certain embodiments, the systems, methods, processes, devices, components, functionality, and features described in the present disclosure can be incorporated into and/or adapted to operate with state-of-the art or equivalent technologies that are in the process of being developed, will be developed in the future, or a combination thereof.

In certain embodiments, any device in the system 100 may transmit a signal to a memory device to cause the memory device to only dedicate a selected amount of memory resources to the various operations of the system 100. In certain embodiments, the system 100 and methods may also include transmitting signals to processors and memories to only perform the operative functions of the system 100 and methods at time periods when usage of processing resources and/or memory resources in the system 100 is at a selected value. In certain embodiments, the system 100 and methods may include transmitting signals to the memory devices utilized in the system 100, which indicate which specific sections of the memory should be utilized to store any of the data utilized or generated by the system 100. Notably, the signals transmitted to the processors and memories may be utilized to optimize the usage of computing resources while executing the operations conducted by the system 100. As a result, such functionality provides substantial operational efficiencies and improvements over existing technologies.

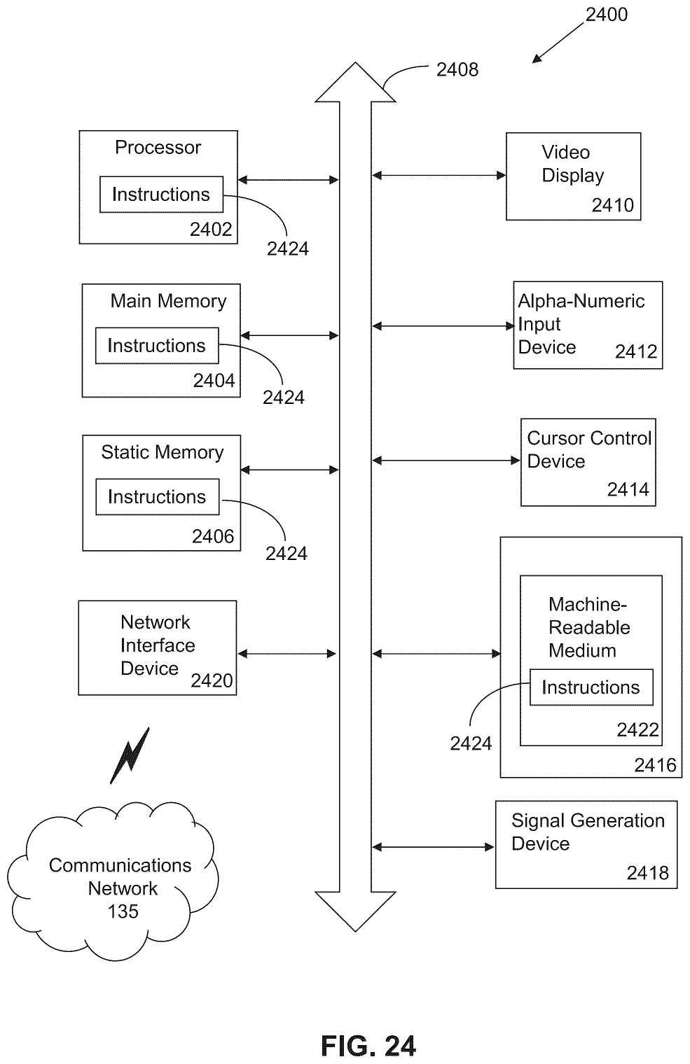

Referring now also to FIG. 24, at least a portion of the methodologies and techniques described with respect to the exemplary embodiments of the system 100 can incorporate a machine, such as, but not limited to, computer system 2400, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100. As another example, the computer system 2400 may assist with capturing media content of objects in an environment, detecting objects in the environment, identifying the objects in the environment, analyzing the objects in the environment, determining conditions associated with the objects in the environment, retrieving metadata associated with objects, determining that an object detected in an environment matches with an object stored in a profile of a user, classifying objects as new assets in a profile of a user, generating metadata associated with an object, training the machine learning models utilized by the system 100, or a combination thereof. As another example, the computer system 2400 may assist with detecting markings on objects, associating detected objects with a profile of a user, performing actions with respect to an object, performing any other functionality provided by the system 100, or a combination thereof.

In certain embodiments, the machine may operate as a standalone device. In some embodiments, the machine may be connected (e.g., using communications network 135, another network, or a combination thereof) to and assist with operations performed by other machines and systems, such as, but not limited to, the first user device 102, the second user device 111, the server 140, the server 145, the server 150, the database 155, the server 160, any other system, program, and/or device, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 2400 may include a processor 2402 (e.g., a central processing unit (CPU), a graphics processing unit (GPU, or both), a main memory 2404 and a static memory 2406, which communicate with each other via a bus 2408. The computer system 2400 may further include a video display unit 2410, which may be, but is not limited to, a liquid crystal display (LCD), a flat panel, a solid state display, or a cathode ray tube (CRT). The computer system 2400 may include an input device 2412, such as, but not limited to, a keyboard, a cursor control device 2414, such as, but not limited to, a mouse, a disk drive unit 2416, a signal generation device 2418, such as, but not limited to, a speaker or remote control, and a network interface device 2420.

In certain embodiments, the disk drive unit 2416 may include a machine-readable medium 2222 on which is stored one or more sets of instructions 2424, such as, but not limited to, software embodying any one or more of the methodologies or functions described herein, including those methods illustrated above. The instructions 2424 may also reside, completely or at least partially, within the main memory 2404, the static memory 2406, or within the processor 2402, or a combination thereof, during execution thereof by the computer system 2400. In certain embodiments, the main memory 2404 and the processor 2402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 2422 containing instructions 2424 so that a device connected to the communications network 135, another network, or a combination thereof, can send or receive voice, video or data, and communicate over the communications network 135, another network, or a combination thereof, using the instructions. The instructions 2424 may further be transmitted or received over the communications network 135, another network, or a combination thereof, via the network interface device 2420.

While the machine-readable medium 2422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. In certain embodiments, the “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A system, comprising:
a memory that stores instructions; and
a processor that executes the instructions to configure the processor to:
analyze, by utilizing at least one machine learning model, media content associated with at least one first object;
identify the at least one first object based on analyzing the media content and by utilizing at least one computer vision technique utilized by the at least one machine learning model;
determine whether the at least one first object matches at least one second object corresponding to an asset of a plurality of assets associated with a profile;
determine, based on the at least one first object being determined to match the at least one second object, that the at least one first object is the at least one second object;
retrieve, based on the at least one first object matching the at least one second object, metadata associated with the at least one second object; and
classify, based on the at least one first object being determined to not match the at least one second object, the at least one first object as a new asset for inclusion in the plurality of assets associated with the profile.

2. The system of claim 1, further comprising at least one sensor configured to scan the at least one first object or capture the media content associated with the at least one first object, and wherein the processor is further configured to present a holographic label on the at least one first object, in proximity to the at least one first object, or a combination thereof, wherein the processor is configured to enable, if the at least one first object matches the at least one second object, the metadata associated with the at least one second object to be presented in response to an interaction with the holographic label.

3. The system of claim 1, wherein the processor is further configured to utilize the at least one machine learning model to perform feature extraction on the media content, conduct object detection, conduct image captioning, conduct image classification, conduct text classification, conduct audio classification, conduct video classification, or a combination thereof, to:
identify the at least one first object; and
determine whether the at least one first object matches the at least one second object.

4. The system of claim 1, wherein the processor is further configured to determine whether an anomaly exists for the at least one first object by comparing the media content to the metadata, prior media content taken of the at least one first object, activity performed by or on the at least one first object, behavior conducted by or on the at least one first object, at least one manufacturer specification associated with the at least one first object, at least one specification specified by an owner of the at least one first object, or a combination thereof.

5. The system of claim 1, wherein the system further comprises:
an input device configured to mark the at least one first object with a first mark to facilitate identification of the at least one first object;
wherein the processor is further configured to:
identify the at least one first object based on the first mark; and
qualify the first mark to be associated with that least one first object by generating a unique identifier to associate the first mark with the at least one first object.

6. The system of claim 1, wherein the processor is further configured to convert the media content, the metadata, or a combination thereof into a token, a series of tokens, or a combination thereof.

7. The system of claim 1, wherein the processor is further configured to train the at least one machine learning model by utilizing training data comprising training content, object specifications, manufacturer specifications, feedback relating to an accuracy of at least one determination or prediction made by the at least one machine learning model, or a combination thereof.

8. The system of claim 1, wherein the processor is further configured to update the metadata based on information obtained from the media content.

9. The system of claim 1, wherein the processor is further configured to automatically generate content describing the at least one first object by utilizing image captioning.

10. The system of claim 1, wherein the processor is further configured to display the metadata associated with the at least one second object on a user interface of a device.

11. The system of claim 1, wherein the metadata comprises a size of the at least one first object, a shape of the at least one first object, a dimension of the at least one first object, an life expectancy of the at least one first object, an identification of an alternate object that serves as a substitute for the at least one first object, repair information for the at least one first object, warranty information for the at least one first object, service information for the at least one first object, at least one recommendation associated with the at least one first object, or a combination thereof.

12. The system of claim 1, wherein the processor is further configured to capture the media content associated with the at least one first object by utilizing a camera, a sensor, a computing device, or a combination thereof.

13. The system of claim 1, wherein the processor is configured to organize the plurality of assets within the profile and according to at least one criteria.

14. A method, comprising:
analyzing, by utilizing instructions from a memory that are executed by a processor and by utilizing at least one machine learning model, media content associated with at least one first object;
identifying the at least one first object based on analyzing the media content and by utilizing at least one computer vision technique utilized by the at least one machine learning model;
determining whether the at least one first object matches at least one second object corresponding to an asset of a plurality of assets associated with a profile;
determining, based on the at least one first object matching the at least one second object, that the at least one first object is the at least one second object;
obtaining, based on the at least one first object matching the at least one second object, metadata associated with the at least one second object; and
classifying, based on the at least one first object being determined to not match the at least one second object, the at least one first object as a new asset for inclusion in the plurality of assets associated with the profile.

15. The method of claim 14, further comprising determining a condition associated with the at least one first object based on utilizing the at least one machine learning model to analyze the media content associated with the at least one first object.

16. The method of claim 14, further comprising generating the metadata based on analyzing the media content, based on a manual input by a user, based on a signal from at least one other object, or a combination thereof.

17. The method of claim 14, further comprising marking the at least one first object by utilizing an infrared pen, an ultraviolet pen, or a combination thereof.

18. The method of claim 17, further comprising utilizing semantic segmentation to perform the marking of the at least one first object.

19. The method of claim 14, further comprising determining whether the at least one first object needs to be repaired, replaced, modified, maintained, or a combination thereof, based on the analyzing of the media content.

20. A non-transitory computer-readable medium comprising instructions, which, when loaded and executed by a processor cause the processor to be configured to:
analyze, by utilizing at least one machine learning model media content associated with at least one first object;
identify the at least one first object based on analyzing the media content and by utilizing at least one computer vision technique utilized by the at least one machine learning model;
determine whether the at least one first object matches at least one second object corresponding to an asset of a plurality of assets associated with a profile;
determine, based on the at least one first object being determined to match the at least one second object, that the at least one first object is the at least one second object;
retrieve, based on the at least one first object matching the at least one second object, metadata associated with the at least one second object; and
classify, based on the at least one first object being determined to not match the at least one second object, the at least one first object as a new asset for inclusion in the plurality of assets associated with the profile.
